(19) United States
(12) Patent Application Publication
(10) Pub. No.: US 2014/0156314 A1
(43) Pub. Date: Jun. 5, 2014

(54) SYSTEM AND METHOD FOR TRADING SENIOR LIFE SETTLEMENT POLICIES

(71) Applicant: John Gunn, Cheshunt (GB)

(72) Inventor: John Gunn, Cheshunt (GB)

(21) Appl. No.: 14/090,874

(22) Filed: Nov. 26, 2013

Related U.S. Application Data
(60) Provisional application No. 61/731,957, filed on Nov. 30, 2012.
(60) Provisional application No. 61/784,091, filed on Mar. 14, 2013.

(51) Int. Cl. G06Q 40/08

(52) U.S. Cl. CPC G06Q 40/08
USPC 705/4

(57) ABSTRACT

A system and method for an exchange for auctioning senior life settlement policies are provided. The system and method may include a member creation system for approving new members, a policy approval and dematerialization system for approving and dematerializing a senior life settlement policy prior to being made available for auction, a policy listing system for selecting an approved and dematerialized senior life settlement policy for auction and for entering dynamic policy data to govern the auction for the selected senior life settlement policy, an auction system for accepting bids and determining whether an auction has been successful or whether an auction needs to be extended, and a trade confirmation system for confirming successful auctions and for tracking settlement of transactions which must occur within three business days of the date of auction.

### CROSS-REFERENCE TO RELATE) APPLICATIONS

This patent application makes reference to, claims priority to and claims benefit from U.S. Provisional Patent Application Ser. No. 61/731,957, entitled “System and Method For Trading Senior Life Settlement Policies” and filed Nov. 30, 2012 and U.S. Provisional Patent Application Ser. No. 61/784,091, entitled “System and Method For Trading Senior Life Settlement Policies” and filed Mar. 14, 2013.

### BACKGROUND OF THE INVENTION

Generally this application relates to electronic financial exchanges. In particular, this application relates to an electronic financial exchange to create a liquid market for trading senior life settlement policies.

Life insurance is a contract between an insurance policy holder and an insurance carrier under which the insurance carrier agrees to pay a predetermined amount of money to a designated beneficiary upon the death of the person insured by the policy. In a traditional scenario, the insurance policy holder (who is frequently also the insured) pays premiums to keep the life insurance policy in force. When the insured dies, the insurance carrier pays to the beneficiary the death benefit owed under the life insurance policy. In this scenario, the insured never enjoys the death benefit paid by the insurance carrier.

It is possible for the insurance policy holder to realize some financial benefit from the life insurance policy while the insured is still alive. The insurance policy holder may elect to sell the life insurance policy to a buyer who buys the policy for less than its full value in what is called a settlement transaction, which creates an asset held by the buyer called a senior life settlement policy. In the settlement transaction, the buyer then assumes the obligation to continue making premium payments to keep the underlying life insurance policy in force but also enjoys the right to name a new beneficiary to whom the death benefit will be paid upon the death of the insured. The senior life settlement policy is now an asset that may be sold to another buyer.

The market for buying and selling senior life settlement policies at present is inefficient. It is the object of the system and method described to create an exchange that creates an efficient, liquid market for senior life settlement policies.

### BRIEF SUMMARY OF THE INVENTION

The system and method described relates to creating an exchange for the efficient buying and selling of senior life settlement policies. The exchange system and method may include a member creation system to create and approve members for access to the exchange system; a policy approval and dematerialization system to approve policies before they are made available for auction, to create a digital representation of each policy document and supporting policy documents, and to ensure that ownership of each senior life settlement policy is transferred to a third party securities intermediary (which is an institution that serves as the owner of each senior life settlement policy made available for auction) prior to the senior life settlement policy being made available for auction; a policy listing system to enter dynamic policy data that will govern the auction of each senior life settlement policy and to list each senior life settlement policy for auction; an auction system to conduct the auction for each senior life settlement policy available for auction, and a trade confirmation system to confirm and settle each successful auction transaction of a senior life settlement policy.

The member creation system may include an operations application entry user computer, a member creation module, a member database, a first operations user computer, a second operations user computer, a third operations user computer, an Nth operations user computer, a login credentials transmission system, and a member computer. The member creation system may be used to approve applications for membership to the exchange system. Data representing applications for membership may be entered into the operations application entry user computer, communicated to the member creation module, and stored in the member database. The application data may then be reviewed on the first operations user computer, the second operations user computer, the third operations user computer, and the Nth operations user computer before the application is approved and membership is granted. If the application is approved and membership is granted, the member creation module may then communicate such approval to the login credentials transmission system, thus prompting the login credentials transmission system to generate login credentials for the newly approved member and to then communicate the login credentials to the member database and to the member computer.

The policy approval and dematerialization system may include a member computer, a member access system, the member database, a policy approval module, an approved policy database, a securities intermediary system, a securities intermediary database, an operations policy review computer, and a securities intermediary computer. The member may submit login credentials through the member computer which are communicated to the member access system. The member access system may compare the login credentials to data stored in the member database. If the login credentials match data stored in the member database, the member computer may communicate with the policy approval module. Using the policy approval module, the member may then select through the member computer, from a list of senior life settlement policies associated with that member, a senior life settlement policy and supporting policy documentation to be approved and dematerialized. Supporting policy documentation may include but is not intended to be limited to, for example, an in-force policy illustration detailing coverage up to at least the termination of coverage date, a current annual statement capturing charges and payments generated in the year that precedes the most recent anniversary of the policy date, verification of coverage issued by the insurer, updated medical records, the identity of the most recent medical underwriter, the identity of the primary insured and secondary insured, and details regarding any outstanding loans taken out against the policy. The member may also optionally submit a premium stream that will maintain the policy in-force through the date that is 30 calendar days after the settlement date and through the termination of coverage date. The selected senior life settlement policy and supporting policy documentation may then be sent to the policy approval module, which may store data representing the senior life settlement policy and supporting policy documentation in the approved policy database. Throughout the specification, references to senior life settlement policies and supporting policy documentation should be understood to include data representing senior life settlement policies and supporting policy documentation, which is created after physical, hard copy documentation has been scanned or digitized and which is capable of being stored in an electronic database or processed by software or displayed on a screen. The policy approval module may also communicate the data representing the selected senior life settlement policy and supporting policy documentation to the securities intermediary system, which then may store the data representing the selected senior life settlement policy and supporting policy documentation in the securities intermediary database. After the data representing the selected senior life settlement policy and supporting policy documentation have been received by the policy approval module, the data representing the selected senior life settlement policy and supporting policy documentation may be reviewed on the operations policy review computer before the selected senior life settlement policy is approved for auction. If the selected senior life settlement policy is approved for auction, ownership of the selected senior life settlement policy may then be transferred to the securities intermediary. Data indicating that title to the selected senior life settlement policy has been transferred to the securities intermediary may be stored in the approved policy database and the securities intermediary database. After ownership of the selected senior life settlement policy may be transferred to the securities intermediary, any information in the selected senior life settlement policy that identifies the insured person may be removed or redacted. The policy may then be approved and dematerialized.

The policy listing system may include a listing member computer, the member access system, the member database, a policy listing module, the approved policy database, and a market listed policy database. The listing member may submit login credentials through the listing member computer which are communicated to the member access system. The member access system may compare the login credentials to data stored in the member database. If the login credentials match data stored in the member database, the member computer may communicate with the policy listing module. Using the policy listing module, the listing member may select through the listing member computer a senior life settlement policy to list for auction from a list of approved and dematerialized senior life settlement policies associated with that member that are stored in the approved policy database. The member may then submit updated supporting policy documentation to have personal identifying information redacted. The member may then enter dynamic policy data that govern certain parameters for the auction. The senior life settlement policy selected by the listing member and the dynamic policy data entered by the listing member may be stored in the market listed policy database. The senior life settlement policy selected by the listing member may then be ready for auction.

The auction system may include an auction information database, the approved policy database, an auction module, the market listed policy database for storing dynamic policy data, the member access system, the member database, a buyer member computer, a seller member computer, the trade confirmation system, and the policy listing module. The buyer member may submit login credentials through the buyer member computer which are communicated to the member access system. The member access system may compare the buyer member login credentials to data stored in the member database. If the login credentials match data stored in the member database, the buyer member computer may communicate with the auction module. Using the auction module, the buyer member may then query for and enter bids on senior life settlement policies available for auction. The auction module may store a bid history associated with each senior life settlement policy in the auction information database. The auction module may also use data stored in the market listed policy database to determine when an auction period for a particular senior life settlement policy is closed, whether a successful auction has occurred, and if not, whether the auction for a particular senior life settlement may be extended. If the auction module has determined that a successful auction has occurred, then the auction module may communicate data relating to the successful auction to the trade confirmation system.

The trade confirmation system may include a trade confirmation database, a trade confirmation module, the securities intermediary system, a trade settlement database, the buyer member computer, and the seller member computer. The trade confirmation module may receive a communication from the auction module that a successful auction occurred and may store data from that communication in the trade confirmation database. The trade confirmation module may also communicate that data to the securities intermediary system, which may then store that data in the trade settlement database. The securities intermediary then settles the trade within three business days of the date of the auction. After the securities intermediary has settled the trade, the buyer member computer and seller member computer may receive communications notifying them that the trade was settled.

The exchange system may additionally include an elective services system. There may be at least two types of elective services provided through the elective services system. The first type of elective service may be policy servicing, whereby the member may request that the exchange pay the premiums on an underlying life insurance policy to ensure that it remains in force while it is being made available for auction. The second type of elective service may be to allow a member to order reports from third parties, whereby the member may obtain reports such as life expectancy reports, medical reports, mortality reports, a background check, a report including the net worth of an underlying insured individual, premium source check, verification of coverage, and updated senior life settlement documentation, or other reports that the member may find useful in deciding whether to bid on a senior life settlement policy available for auction. The elective services system may include a requesting member computer, the member access system, the member database, an elective services module, a report database, and a policy servicing database. The requesting member may submit login credentials through the requesting member computer which are communicated to the member access system. The member access system may compare the login credentials to data stored in the member database. If the login credentials match data stored in the member database, the requesting member computer may communicate with the elective services module. Using the elective services module, the requesting member may request servicing of any senior life settlement policies owned by the requesting member or the member may request any third party reports for information about any senior life settlement policies that are listed on the exchange system. The elective services module may store requests for policy servicing in the policy servicing database. The elective services module may store requests for third party reports and third party reports in the report database.

The exchange system may additionally include a reporting system for members of the exchange to request reports that are based on data stored in the exchange system. The reporting system may include a computer through which a member may request a report, the member access system, the member database, a report module, the approved policy database, the market listed policy database, the auction information database, and the trade confirmation database. The member requesting a report may submit login credentials through a computer which are communicated to the member access system. The member access system may compare the login credentials to data stored in the member database. If the login credentials match data stored in the member database, the computer through which the member requested a report may communicate with the report module. Using the report module, the member may request reports on data stored in any of the approved policy database, the market listed policy database, the auction information database, or the trade confirmation database, or any combination thereof. The report module then retrieves the requested data and generates a report that is sent to the computer through which the member requested the report.

### BRIEF DESCRIPTION OF THE DRAWINGS

FIG. 1 is a block diagram illustrating an embodiment of the exchange system 100.

FIG. 2 is a block diagram illustrating an embodiment of a member creation system 200 for approving applicants as members.

FIG. 3 is a block diagram illustrating an embodiment of a policy approval and dematerialization system 300 for approving and dematerializing senior life settlement policies prior to being listed for auction.

FIG. 4 is a block diagram illustrating an embodiment of a policy listing system 400 through which members list senior life settlement policies for auction.

FIG. 5 is a block diagram illustrating an embodiment of an auction system 500 through which the auction of senior life settlement policies takes places.

FIG. 6 is a block diagram illustrating an embodiment of a trade confirmation system 600.

FIG. 7 is a block diagram illustrating an embodiment of an elective services system 700 through which members may request elective services such as policy premium payment or third party reports.

FIG. 8 is a flow chart illustrating an example method 800 for approving members of the exchange system.

FIG. 9 is a flow chart illustrating an example method 900 for approving and dematerializing senior life settlement policies prior to auction.

FIG. 10 is a flow chart illustrating one example method 1000 for listing on the exchange for auction.

FIG. 11 is a flow chart illustrating one example method 1100 for conducting the auction.

FIG. 12 is a flow chart illustrating one example method 1200 for confirming a trade.

FIG. 13 is a block diagram illustrating an embodiment of a reporting system 1300 through which members may request reports.

FIG. 14 is a flow chart illustrating one example method 1400 for performing elective services.

FIG. 15 is a flow chart illustrating one example method 1500 for providing reports.

### DETAILED DESCRIPTION OF THE INVENTION

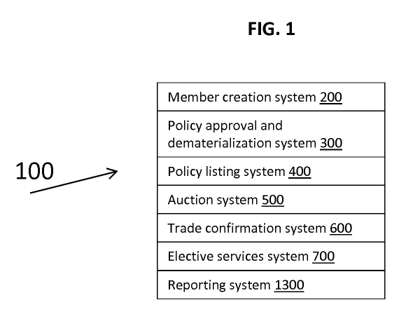

FIG. 1 is a block diagram illustrating an embodiment of an exchange system 100. The exchange system 100 includes a member creation system 200, a policy approval and dematerialization system 300, a policy listing system 400, an auction system 500, and a trade confirmation system 600.

The member creation system 200 is in communication with the policy approval and dematerialization system 300, the policy listing system 400, the auction system 500, and the trade confirmation system 600. The policy approval and dematerialization system 300 is further in communication with the policy listing system 400, the auction system 500, and the trade confirmation system 600. The policy listing system 400 is further in communication with the auction system 500, and the trade confirmation system 600. The auction system 500 is further in communication with the trade confirmation system 600.

In operation, members of the exchange system 100 are created and approved in the member creation system 200, as further described below. After members are approved, they can upload data representing senior life settlement policies and supporting documentation to the exchange system 100 through the policy approval and dematerialization system 300, in which the senior life settlement policies are approved and dematerialized prior to being made available for auction, as further described below. After senior life settlement policies have been approved and dematerialized, they may be made available for auction through the policy listing system 400, as further described below. After senior life settlement policies have been made available for auction, buying members can view and bid on any senior life settlement policies that are available for auction in the auction system 500, as further described below. Finally, after a buying member has successfully bid for a senior life settlement policy, the trade confirmation system 600 confirms that the auction has completed, as further described below.

In another embodiment, the exchange system 100 may further include an elective services system 700, as further described below. Members may request elective services through the elective services system 700 including, for example, requests for servicing of life insurance policies whereby the exchange may pay the remaining premiums on an underlying life insurance policy owned by a member to ensure that the underlying life insurance policy remains in force while it is being auctioned. Members may additionally request third party reports to assist them in making informed decisions about whether to place a bid on a senior life settlement policy available for auction and if so, how much to bid. For example, and not intending to be limited in any way to the following, third party reports may include life expectancy reports, medical reports, mortality reports, a background check, a report including the net worth of an underlying insured individual, premium source check, verification of coverage, and updated senior life settlement documentation, or other reports. In this embodiment, the elective services system 700 is in communication with the member creation system 200, the policy approval and dematerialization system 300, the policy listing system 400, the auction system 500, and the trade confirmation system 600.

In another embodiment, the exchange system 100 may further include a reporting system 800, as further described below. Members may request reports through the reporting system 800 to determine, for example, the number of transactions that occurred in the exchange system 100 during a certain time period, the average price of transactions that occurred in the exchange system 100 during a certain time period, the status of any senior life settlement policy listed for auction in the exchange system 100, or other information. This list is by way of example only and is not intended to limit in any way the type of reports potentially available to a member based on data stored in the databases that are part of the exchange system 100. In this embodiment, the reporting system 800 is in communication with the member creation system 200, the policy approval and dematerialization system 300, the policy listing system 400, the auction system 500, the trade confirmation system 600, and the elective services system 700.

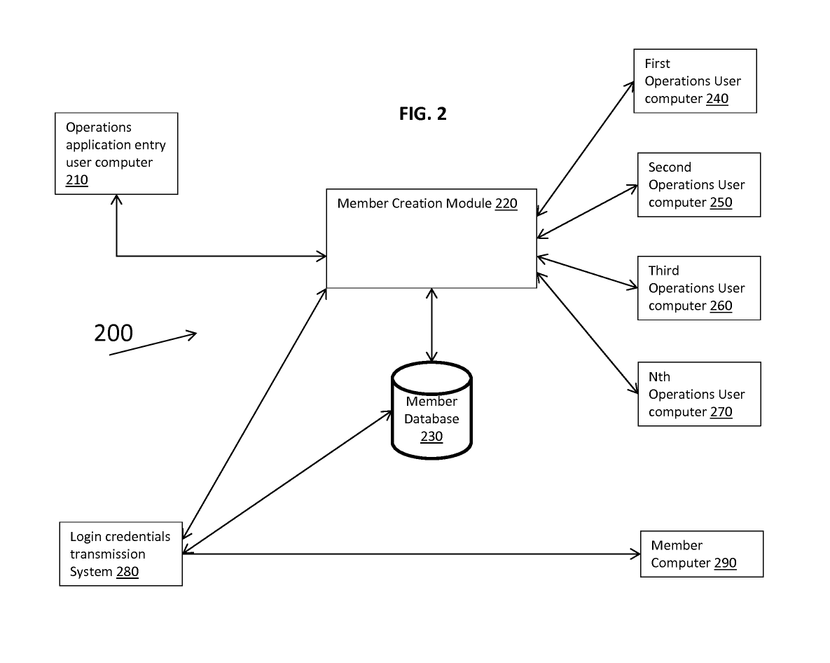

FIG. 2 is a block diagram illustrating an embodiment of the member creation system 200 for approving applicants as members of the exchange system 100. The member creation system 200 includes an operations application entry user computer 210, a member creation module 220, a member database 230, a first operations user computer 240, a second operations user computer 250, a third operations user computer 260, an Nth operations user computer 270, a login credentials transmission system 280, and a member computer 290.

The operations application entry user computer 210 is in communication with the member creation module 220. The member creation module 220 is further in communication with the member database 230, the first operations user computer 240, the second operations user computer 250, the third operations user computer 260, the Nth operations user computer 270, and the login credentials transmission system 280. The login credentials transmission system 280 is further in communication with the member database 230 and the member computer 290.

In operation, a data entry user (not shown) receives from an applicant an application for membership to the exchange system 100, and the data entry user enters data representing the application for membership into the operations application entry user computer 210. The operations application entry user computer 210 communicates the data representing the application for membership to the member creation module 220. The member creation module 220 receives the data from the operations application entry user computer 210 and enters the data into the member database 230 where it is stored.

After the data representing the application is stored in the member database 230, the member creation module 220 generates an electronic notification that is sent to the first operations user computer 240 indicating that the application is ready for review. A first operations user (not shown) enters data into the first operations user computer 240 indicating that the first operations user is ready to review the data representing the application. The first operations user computer 240 communicates the data indicating that the first operations user is ready to review the data representing the application to the member creation module 220. The member creation module 220 receives the data indicating that the first operations user is ready to review the data representing the application and in response, the member creation module 220 retrieves at least some of the data representing the application from the member database 230. Then, the member creation module 220 communicates the retrieved data to the first operations user computer 240 where it is displayed.

The first operations user then checks the data displayed on the first operations user computer 240 against a first checklist. After the data displayed on the first operations user computer 240 has been checked against the first checklist by the first operations user, the first operations user enters data into the first operations user computer 240 that represents a first status of the application, such as whether it is approved or rejected. The first operations user computer 240 communicates the data representing the first status of the application entered by the first operations user to the member creation module 220. The member creation module 220 receives the data representing the first status of the application and then enters it in the member database 230.

If the data received by the member creation module 220 from the first operations user computer 240 indicates that the application has been rejected by the first operations user, then the application is rejected.

If the data received by the member creation module 220 from the first operations user computer 240 indicates that the application has been approved by the first operations user, the member creation module 220 generates an electronic notification that is sent to the second operations user computer 250 indicating that the application is ready for review by a second operations user (not shown).

The second operations user enters data indicating that the second operations user is ready to review the data representing the application into the second operations user computer 250. The second operations user computer 250 communicates the data indicating that the second operations user is ready to review the data representing the application to the member creation module 220. The member creation module 220 receives the data indicating that the second operations user is ready to review the data representing the application and in response, the member creation module 220 retrieves at least some of the data representing the application from the member database 230. Then, the member creation module 220 communicates the retrieved data to the second operations user computer 250 where it is displayed.

The second operations user then checks the data displayed on the second operations user computer 250 against a second checklist. After the data representing the application has been checked against the second checklist by the second operations user, the second operations user enters data into the second operations user computer 250 that represents the second status of the application, such as whether it is approved or rejected. The second operations user computer 250 communicates the data representing the second status of the application entered by the second operations user to the member creation module 220. The member creation module 220 receives the data representing the second status of the application entered by the second operations user and then enters it in the member database 230.

If the data received by the member creation module 220 from the second operations user computer 250 indicates that the application has been rejected by the second operations user, then the application is rejected.

If the data received by the member creation module 220 from the second operations user computer 250 indicates that the application has been approved by the second operations user, the member creation module 220 generates an electronic notification that is sent to the third operations user computer 250 that the application is ready for review by a third operations user (not shown).

The third operations user enters data indicating that the third operations user is ready to review the data representing the application into the third operations user computer 260. The third operations user computer 260 communicates the data indicating that the third operations user is ready to review the data representing the application to the member creation module 220. The member creation module 220 receives the data indicating that the third operations user is ready to review the data representing the application and in response, the member creation module 220 retrieves at least some of the data representing the application from the member database 230. Then, the member creation module 220 communicates the retrieved data to the third operations user computer 260 where it is displayed.

The third operations user then checks the data displayed on the third operations user computer 260 against a third checklist. After the data representing the application has been checked against the third checklist by the third operations user, the third operations user enters data into the third operations user computer 260 that represents the third status of the application, such as whether it is approved or rejected. The third operations user computer 260 communicates the data representing the third status of the application entered by the third operations user to the member creation module 220. The member creation module 220 receives the data representing the third status of the application entered by the third operations user and then enters it in the member database 230.

If the data received by the member creation module 220 from the third operations user computer 260 indicates that the application has been rejected by the third operations user, then the application is rejected.

If the data received by the member creation module 220 from the third operations user computer 260 indicates that the application has been approved by the third operations user, the application is approved and the potential member may now be considered a member, and the member creation module 220 may send an electronic notification to the login credentials transmission system 280 to generate the login credentials for the new member.

In another embodiment, the application may be reviewed N times if the data received by the member creation module 220 from the third operations user computer 260 indicates that the application has been approved by the third operations user. Then, the member creation module 220 generates an electronic notification that is sent to the Nth operations user computer 270 that the application is ready for review by an Nth operations user (not shown).

The Nth operations user enters data indicating that the Nth operations user is ready to review the data representing the application into the Nth operations user computer 270. The Nth operations user computer 270 communicates the data indicating that the Nth operations user is ready to review the data representing the application to the member creation module 220. The member creation module 220 receives the data indicating that the Nth operations user is ready to review the data representing the application and in response, the member creation module 220 retrieves at least some of the data representing the application from the member database 230. Then, the member creation module 220 communicates the retrieved data to the Nth operations user computer 270 where it is displayed.

The Nth operations user then checks the data displayed on the Nth operations user computer 270 against an Nth checklist. After the data representing the application has been checked against the Nth checklist by the third operations user, the Nth operations user enters data into the Nth operations user computer 270 that represents the Nth status of the application, such as whether it is approved or rejected. The Nth operations user computer 270 communicates the data representing the Nth status of the application entered by the Nth operations user to the member creation module 220. The member creation module 220 receives the data representing the Nth status of the application entered by the Nth operations user and then enters it in the member database 230.

In this embodiment, if the data received by the member creation module 220 from the Nth operations user computer 270 indicates that the application has been approved by the Nth operations user, the application is approved and the potential member may now be considered a member, and the member creation module 220 may send an electronic notification to the login credentials transmission system 280 to generate the login credentials for the new member.

Once it has been determined that an application for membership has been approved, the member creation module 220 may send an electronic notification to the login credentials transmission system 280 to generate the login credentials for the new member. The login credentials transmission system 280 receives the electronic notification from the member creation module 220 and generates the login credentials which are then stored in the member database 230. After the login credentials have been generated and stored in the member database 230, the login credentials transmission system 280 generates an electronic notification including the login credentials that is sent to the member computer 290.

In another embodiment, the operations application entry user computer 210, first operations user computer 240, second operations user computer 250, third operations user computer 260, Nth operations user computer 270, and member computer 290 each may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the operations application entry user computer 210, first operations user computer 240, second operations user computer 250, third operations user computer 260, Nth operations user computer 270, and member computer 290 may each be a computing device such as a personal computer, laptop computer, personal digital assistant, smart phone, tablet computer, or other computing device.

In another embodiment, the member creation module 220 may be a software program containing a set of instructions stored in at least one computer-readable medium that are executable to cause a system to perform operations based on the instructions.

In another embodiment, the member creation module 220 may be stored on a server, a plurality of servers, a mobile server, a desktop computer, a workstation, a laptop computer, in a cloud computing network, or other similar computing device.

In another embodiment, the login credentials transmission system 280 may be a software program containing a set of instructions stored in at least one computer-readable medium that are executable to cause a system to perform operations based on the instructions.

In another embodiment, the login credentials transmission system 280 may be stored on a server, a plurality of servers, a mobile server, a desktop computer, a workstation, a laptop computer, in a cloud computing network, or other similar computing device.

In another embodiment, the member database 230 may be an electronic database.

in another embodiment, the communication between the operations application entry user computer 210 and the member creation module 220 may be through a network connection, Ethernet connection, internet connection, file transfer protocol connection, RF connection, infrared connection, wireless connection, photonic connection, or other electronic connection.

In another embodiment, the communication between the member creation module 220 and the first operations user computer 240 may be through a network connection, Ethernet connection, internet connection, file transfer protocol connection, RF connection, infrared connection, wireless connection, photonic connection, or other electronic connection.

In another embodiment, the communication between the member creation module 220 and the second operations user computer 250 may be through a network connection, Ethernet connection, internet connection, file transfer protocol connection, RF connection, infrared connection, wireless connection, photonic connection, or other electronic connection.

In another embodiment, the communication between the member creation module 220 and the third operations user computer 260 may be through a network connection, Ethernet connection, internet connection, file transfer protocol connection, RF connection, infrared connection, wireless connection, photonic connection, or other electronic connection.

In another embodiment, the communication between the member creation module 220 and the Nth operations user computer 270 may be through a network connection, Ethernet connection, internet connection, file transfer protocol connection, RF connection, infrared connection, wireless connection, photonic connection, or other electronic connection.

In another embodiment, the communication between the member creation module 220 and the member database 230 may be through a network connection, SQL connection, Ethernet connection, internet connection, file transfer protocol connection, RF connection, infrared connection, wireless connection, photonic connection, or other electronic connection.

In another embodiment, the communication between the member creation module 220 and the login credentials transmission system 280 may be through a network connection, Ethernet connection, internet connection, file transfer protocol connection, RF connection, infrared connection, wireless connection, photonic connection, or other electronic connection.

In another embodiment, the communication between the login credentials transmission system 280 and the member computer 290 may be through a network connection, Ethernet connection, internet connection, file transfer protocol connection, RF connection, infrared connection, wireless connection, photonic connection, or other electronic connection.

In another embodiment, the communication between the login credentials transmission system 280 and the member database 230 may be through a network connection, SQL connection, Ethernet connection, internet connection, file transfer protocol connection, RF connection, infrared connection, wireless connection, photonic connection, or other electronic connection.

In another embodiment, the operations application entry user computer 210 may process the data representing the member application entered by the operations application entry user and then may communicate a portion of that data to the member creation module 220.

In another embodiment, the user may enter data representing an application for membership in the form of text into a web-based interface supported by the member creation module 220 that is displayed on the operations application entry user computer 210.

In another embodiment, to enter data representing an application for membership into the operations application entry user computer 210, the user may scan the application for membership into the operations application entry user computer 210 using a scanner (not shown).

In another embodiment, the operations application entry user computer 210 may accept, as input, data representing predetermined number of reviewers who will need to review the application before it is considered approved. The number of reviewers who will need to review the application may be set by exchange rules, for example. The operation application entry user computer 210 communicates the data representing the number of reviewers who will need to review the application before it is considered approved to the member creation module 220. The member creation module 220 receives the data representing the number of reviewers who will need to review the application before it is considered approved and enters that data into the member database 230 where it is stored. In this embodiment, the process for reviewing and approving the data representing the application proceeds generally described above, but in addition to receiving data representing the status of the application (either approved or rejected) from each operations user computer (240, 250, 260, and 270) that is then entered into the member database 230, the member database 230 also stores a count value that represents the number of reviewers who have reviewed each application and assigned an approved status to the application. After the member creation module 220 receives data from an operations user workstation (240, 250, 260, or 270) representing the status of an application, if the data corresponds to an “approved” status, the member creation module 220 adds 1 to the count value stored in the member database 230. Then, to determine if another reviewer is required to review the application before the member is approved, the member creation module 220 retrieves count value for the particular application from the member database 230 and the data value representing the number of reviewers who will need to review the application for the particular application. The member creation module 220 then compares those values. If the count value is equal to or greater than the data value, then the application is approved. If the count value is less than the data value, then the member creation module 220 generates an electronic notification that is sent to the next operations user computer. This process proceeds as described above until the count value for a particular application is equal to or greater than the data value for that particular application.

In another embodiment, the data representing the predetermined number of reviewers who will need to review the application before it is considered approved may be entered as text into a web-based interface supported by the member creation module 220 displayed on the operations application entry user computer 210.

In another embodiment, the data representing the predetermined number of reviewers who will need to review the application before it is considered approved may be selected from a drop-down list of values in a web-based interface supported by the member creation module 220 displayed on the operations application entry user computer 210.

In another embodiment, the electronic notification sent by the member creation module 220 to the first operations user computer 240 indicating that an application is ready for review may be viewable through a web-based interface supported by the member creation module 220 displayed on the first operations user computer 240.

In another embodiment, the electronic notification sent by the member creation module 220 to the second operations user computer 250 indicating that an application is ready for review may be viewable in a web-based interface supported by the member creation module 220 displayed on the second operations user computer 250.

In another embodiment, the electronic notification sent by the member creation module 220 to the third operations user computer 260 indicating that an application is ready for review may be viewable in a web-based interface supported by the member creation module 220 displayed on the third operations user computer 260.

In another embodiment, the electronic notification sent by the member creation module 220 to the Nth operations user computer 270 indicating that an application is ready for review may be viewable in a web-based interface supported by the member creation module 220 displayed on the Nth operations user computer 270.

In another embodiment, the data indicating that the first operations user is ready to review the application may be entered as text into a web-based interface supported by the member creation module 220 displayed on the first operations user computer 240.

In another embodiment, the data indicating that the first operations user is ready to review the application may be entered by clicking a button or hyperlink in a web-based interface supported by the member creation module 220 displayed on the first operations user computer 240.

In another embodiment, the data indicating that the second operations user is ready to review the application may be entered as text into a web-based interface supported by the member creation module 220 displayed on the second operations user computer 250.

In another embodiment, the data indicating that the second operations user is ready to review the application may be entered by clicking a button or hyperlink in a web-based interface supported by the member creation module 220 displayed on the second operations user computer 250.

In another embodiment, the data indicating that the third operations user is ready to review the application may be entered as text into a web-based interface supported by the member creation module 220 displayed on the third operations user computer 260.

In another embodiment, the data indicating that the third operations user is ready to review the application may be entered by clicking a button or hyperlink in a web-based interface supported by the member creation module 220 displayed on the third operations user computer 260.

In another embodiment, the data indicating that the Nth operations user is ready to review the application may be entered as text into a web-based interface supported by the member creation module 220 displayed on the Nth operations user computer 270.

In another embodiment, the data indicating that the Nth operations user is ready to review the application may be entered by clicking a button or hyperlink in a web-based interface supported by the member creation module 220 displayed on the Nth operations user computer 270.

In another embodiment, the data representing the membership application sent by the member creation module 220 to the first operations user computer 240 may be displayed in a web-based interface supported by the member creation module 220 displayed on the first operations user computer 240.

In another embodiment, the data representing the membership application sent by the member creation module 220 to the second operations user computer 250 may be displayed in a web-based interface supported by the member creation module 220 displayed on the second operations user computer 250.

In another embodiment, the data representing the membership application sent by the member creation module 220 to the third operations user computer 260 may be displayed in a web-based interface supported by the member creation module 220 displayed on the third operations user computer 260.

In another embodiment, the data representing the membership application sent by the member creation module 220 to the Nth operations user computer 270 may be displayed in a web-based interface supported by the member creation module 220 displayed on the Nth operations user computer 270.

In another embodiment, the first checklist that is used by the first operations user may require that the first operations user check to see if the applicant is a Qualified Institutional Buyer (“QIB”) as defined by the United States Securities Laws.

In another embodiment, after the first operations user has reviewed the data representing the application, to enter the data representing the first status of the application into the first operations user computer 240, the first operations user may enter text into a web-based interface supported by the member creation module 220 displayed on the first operations user computer 240.

In another embodiment, after the first operations user has reviewed the data representing the application, to enter the data representing the first status of the application into the first operations user computer 240, the first operations user may select a value from a pre-populated drop-down list of values in a web-based interface supported by the member creation module 220 displayed on the first operations user computer 240.

In another embodiment, the second checklist that is used by the second operations user may require that the second operations user check to see if the applicant is a Qualified Institutional Buyer (“QIB”) as defined by the United States Securities Laws.

In another embodiment, after the second operations user has reviewed the data representing the application, to enter the data representing the second status of the application into the second operations user computer 250, the second operations user may enter text into a web-based interface supported by the member creation module 220 displayed on the second operations user computer 250.

In another embodiment, after the second operations user has reviewed the data representing the application, to enter the data representing the second status of the application into the second operations user computer 250, the second operations user may select a value from a pre-populated drop-down list of values in a web-based interface supported by the member creation module 220 displayed on the second operations user computer 250.

In another embodiment, the third checklist that is used by the third operations user may require that the third operations user check to see if the applicant is a Qualified Institutional Buyer (“QIB”) as defined by the United States Securities Laws.

In another embodiment, after the third operations user has reviewed the data representing the application, to enter the data representing the third status of the application into the third operations user computer 260, the third operations user may enter text into a web-based interface supported by the member creation module 220 displayed on the third operations user computer 260.

In another embodiment, after the third operations user has reviewed the data representing the application, to enter the data representing the third status of the application into the third operations user computer 260, the third operations user may select a value from a pre-populated drop-down list of values in a web-based interface supported by the member creation module 220 displayed on the third operations user computer 260.

In another embodiment, the Nth checklist that is used by the Nth operations user may require that the Nth operations user check to see if the applicant is a Qualified Institutional Buyer (“QIB”) as defined by the United States Securities Laws.

In another embodiment, after the Nth operations user has reviewed the data representing the application, to enter the data representing the Nth status of the application into the Nth operations user computer 270, the Nth operations user may enter text into a web-based interface supported by the member creation module 220 displayed on the Nth operations user computer 270.

In another embodiment, after the Nth operations user has reviewed the data representing the application, to enter the data representing the Nth status of the application into the Nth operations user computer 270, the Nth operations user may a value from a pre-populated drop-down list of values in a web-based interface supported by the member creation module 220 displayed on the Nth operations user computer 270.

In another embodiment, only one level of approval may be required to approve an application for membership using the process generally as described above. In another embodiment, two levels of approval may be required to approve an application for membership using the process generally as described above.

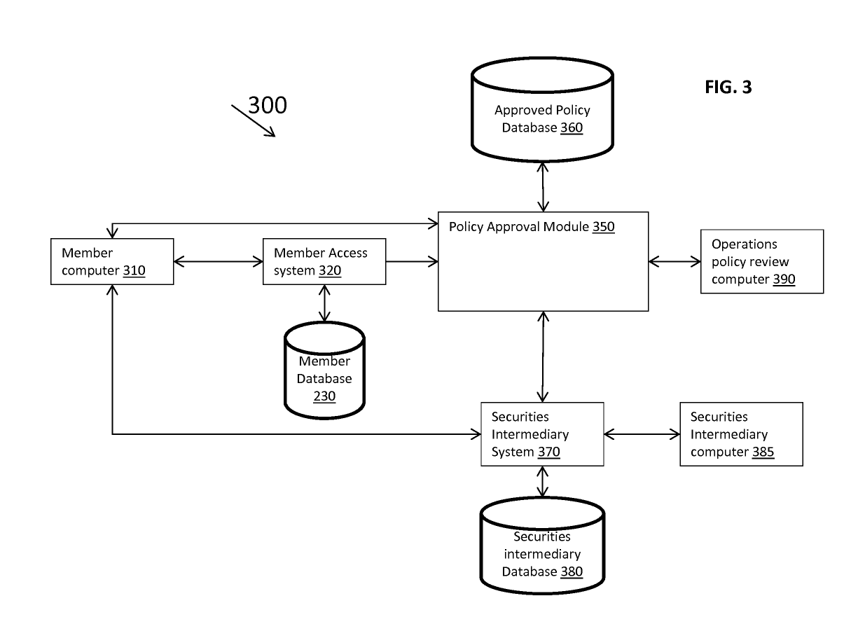

FIG. 3 is a block diagram illustrating an embodiment of the policy approval and dematerialization system 300 for approving and dematerializing senior life settlement policies prior to their being listed for auction the exchange system 100. The policy approval and dematerialization system 300 includes a member computer 310, a member access system 320, the member database 230, a policy approval module 350, an approved policy database 360, a securities intermediary system 370, a securities intermediary database 380, an operations policy review computer 390, and a securities intermediary computer 385.

The member computer 310 is in communication with the member access system 320, the policy approval module 350, and the securities intermediary system 370. The member access system 320 is further in communication with the member database 230, and the policy approval module 350. The policy approval module 350 is further in communication with the approved policy database 360, the securities intermediary system 370, and the operations policy review computer 390. The securities intermediary system 370 is further in communication with the securities intermediary database 380, and the securities intermediary computer 385.

In operation, a member (not shown) may enter an access request into the member computer 310 for access to the policy approval module 350. The member computer 310 receives the access request and processes it to send data representing that access request to the member access system 320. The member computer 310 sends the data representing the access request to the member access system 320. The member access system 320 receives the data representing the access request from the member computer 310 and searches the member database 230 for data that corresponds to the data included in the access request. If member access system 320 finds data in member database 230 that corresponds to the data included in the access request, then the member access system 320 allows the member computer 310 to communicate with the policy approval module 350. If member access system 320 does not find data in member database 230 that corresponds to the data included in the access request, the member access system 320 does not allow the member computer 310 to access the policy approval module 350. If the member access system 320 does not allow the member computer 310 to communicate with policy approval module 350, the member access system 320 sends an electronic notification to the member computer 310 to indicate that access to the policy approval module 350 was denied, where it is displayed.

If the member access system 320 allows the member computer 310 to communicate with the policy approval module 350, the member computer 310 may communicate with the policy approval module 350.

Once the member computer 310 is allowed to communicate with the policy approval module 350, the member inputs into the member computer 310 data representing a senior life settlement policy and supporting policy documentation owned by that member that the member wants to list on the exchange system 100 for auction. The data representing the senior life settlement policy and supporting policy documentation owned by that member that is entered into the member computer 310 is communicated to the policy approval module 350. The policy approval module 350 receives the data representing the senior life settlement policy and supporting policy documentation from the member computer 310 and then enters the data representing the senior life settlement policy and supporting policy documentation received from the member computer 310 into the approved policy database 360. The policy approval module 350 also communicates the data representing the senior life settlement policy and supporting policy documentation to the securities intermediary system 370. The securities intermediary system 370 receives the data representing the senior life settlement policy and supporting policy documentation and enters it into the securities intermediary database 380.

After the data representing the senior life settlement policy and supporting policy documentation has been entered into the approved policy database 360, the policy approval module 350 generates an electronic notification that is sent to the operations policy review computer 390 indicating that a new senior life settlement policy and supporting policy documentation are ready for review. The operations policy reviewer (not shown) enters data indicating that the operations policy reviewer is ready to review the data representing the new senior life settlement policy and supporting policy documentation into the operations policy review computer 390. The operations policy review computer 390 communicates the data indicating that the operations policy reviewer is ready to review the data representing the new senior life settlement policy and supporting policy documentation to the policy approval module 350. The policy approval module 350 receives the data indicating that the operations policy reviewer is ready to review the data representing the new senior life settlement policy and supporting policy documentation. In response, the policy approval module 350 retrieves at least a portion of the data representing the new senior life settlement policy and supporting policy documentation from the approved policy database 360 and communicates the retrieved data to the operations policy review computer 390 where it is displayed.

The operations policy reviewer then checks the data received from the policy approval module 350 and displayed on the operations policy review computer 390 against a policy approval review checklist. After review, the operations policy reviewer enters data into the operations policy review computer 390 that represents the approval status of the new senior life settlement policy, such as whether it is approved or rejected. The operations policy review computer 390 communicates the data representing the approval status of the new senior life settlement policy to the policy approval module 350. The policy approval module 350 receives the data representing the approval status of the new policy and then enters it into the approved policy database 360.

If the approval status of the new senior life settlement policy is that the senior life settlement policy has been approved, the policy approval module 350 then generates an electronic notification indicating that the policy has been approved and communicates that electronic notification to the securities intermediary system 370. The securities intermediary system 370 receives the electronic notification that the policy has been approved and enters data representing that the status of the policy has been approved into the securities intermediary database 380.

After the data representing that the status of the policy has been approved has been entered into the securities intermediary database 380, the securities intermediary system 370 generates an electronic notification that the member who has submitted the policy for approval needs to execute owner change forms and beneficiary change forms designating the securities intermediary as the new owner and beneficiary of the senior life settlement policy, which must be submitted to the insurance provider. These forms must be signed by the member who wishes to list the particular policy to the insurance provider. The electronic notification that the member needs to execute owner change forms and beneficiary change forms is sent to the securities intermediary computer 385 where it is displayed. The securities intermediary user (not shown) reviews this message and prepares the owner change forms and beneficiary change forms. The securities intermediary user then sends these forms to the member who must execute them. After the member executes these forms, the member submits them to the securities intermediary, who also executes them. Then, the securities intermediary sends the executed forms to the insurance carrier. The insurance carrier receives these forms and updates their records associated with the particular policy. The insurance carrier then notifies the securities intermediary that their ownership and beneficiary records have been updated for the particular policy.

When the securities intermediary receives the notification from the insurance carrier that the insurance carrier's records have been updated, the securities intermediary user enters into the securities intermediary computer 385 data representing that the securities intermediary has been designated as the new owner and beneficiary of the policy. The securities intermediary computer 385 then communicates the data representing that the securities intermediary has been designated as the new owner and beneficiary of the policy to the securities intermediary system 370. The securities intermediary system 370 receives the data representing that the securities intermediary has been designated as the new owner and beneficiary of the policy and then sends that data to the policy approval module 350. The policy approval module 350 receives the data from the securities intermediary system 370 representing that the securities intermediary is the new owner and beneficiary of the policy, and then enters that data into the approved policy database 360. The securities intermediary system 370 also generates an electronic message that is sent to the member computer 310 to notify the member that the securities intermediary is now the owner and beneficiary of the policy. The member computer 310 receives that electronic notification and displays it.

Before a senior life settlement policy is made available for auction on exchange system 100, personal identifying information about the insured must be removed from any data representing the particular senior life settlement policy and from any data representing any supporting documentation for the particular senior life settlement policy. In an embodiment, the securities intermediary computer 385 is used to redact personal identifying information about the insured from the data associated with a particular senior life settlement policy and supporting policy documentation. To do this, a securities intermediary user (not shown) enters a request to review at least some of the data representing a particular senior life settlement policy and at least some of the data representing any supporting documentation for the particular senior life settlement policy into the securities intermediary computer 385. The securities intermediary computer 385 sends the request to the securities intermediary system 370. The securities intermediary system 370 receives the request from the securities intermediary computer 385 and then retrieves at least some of the data corresponding to the request from the securities intermediary database 380. After the securities intermediary system 370 retrieves the data corresponding to the request, the securities intermediary system 370 communicates the data to the securities intermediary computer 385 where it is displayed.

The securities intermediary user then reviews the received data representing a particular senior life settlement policy and any supporting policy documentation on the securities intermediary computer 385 and selects the personal identifying information contained that is to be redacted. After the securities intermediary user has selected the personal identifying information that is to be redacted, the securities intermediary computer 385 redacts the selected personal identifying information from the data representing the senior life settlement policy and the supporting policy documentation. Then, the securities intermediary computer 385 sends the data representing the senior life settlement policy and supporting policy documentation with personal identifying data redacted to the securities intermediary system 370. The securities intermediary system 370 receives the data representing a particular senior life settlement policy and any supporting policy documentation with personal identifying information redacted and then enters it in the securities intermediary database 380. The securities intermediary system 370 then communicates the data representing a particular senior life settlement policy and any supporting policy documentation with personal identifying information redacted to the policy approval module 350, which receives the data with personal identifying information redacted. The policy approval module 350 then communicates the data representing a particular senior life settlement policy and any supporting policy documentation with personal identifying information redacted to the approved policy database 360 where it is stored.

In another embodiment, the member computer 310, operations policy review computer 390, and securities intermediary computer 385, each may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the member computer 310, operations policy review computer 390, and securities intermediary computer 385 each may be a computing device such as a personal computer, laptop computer, personal digital assistant, smart phone, tablet computer, or other computing device.

In another embodiment, the member access system 320 may be a software program containing a set of instructions stored in at least one computer-readable medium that are executable to cause a system to perform operations based on the instructions.

In another embodiment, the member access system 320 may be stored on a server, a plurality of servers, a mobile server, a desktop computer, a workstation, a laptop computer, in a cloud computing network, or other similar computing device.

In another embodiment, the policy approval module 350 may be a software program containing a set of instructions stored in at least one computer-readable medium that are executable to cause a system to perform operations based on the instructions.

In another embodiment, the policy approval module 350 may be stored on a server, a plurality of servers, a mobile server, a desktop computer, a workstation, a laptop computer, in a cloud computing network, or other similar computing device.

In another embodiment, the securities intermediary system 370 may be a software program containing a set of instructions stored in at least one computer-readable medium that are executable to cause a system to perform operations based on the instructions.

In another embodiment, the securities intermediary system 370 may be stored on a server, a plurality of servers, a mobile server, a desktop computer, a workstation, a laptop computer, in a cloud computing network, or other similar computing device.

In another embodiment, the member database 230 may be an electronic database.

In another embodiment, the securities intermediary database 380 may be an electronic database.

In another embodiment, the approved policy database 360 may be an electronic database.

In another embodiment, the communication between the member computer 310 and the member access system 320 may be through a network connection, Ethernet connection, internet connection, file transfer protocol connection, RF connection, infrared connection, wireless connection, photonic connection, or other electronic connection.

In another embodiment, the communication between the member computer 310 and the policy approval module 350 may be through a network connection, Ethernet connection, internet connection, file transfer protocol connection, RF connection, infrared connection, wireless connection, photonic connection, or other electronic connection.

In another embodiment, the communication between the member access system 320 and the member database 230 may be through a network connection, Ethernet connection, internet connection, SQL connection, RF connection, infrared connection, wireless connection, photonic connection, or other electronic connection.

In another embodiment, the communication between the member access system 320 and the policy approval module 350 may be through a network connection, Ethernet connection, internet connection, SQL connection, RF connection, infrared connection, wireless connection, photonic connection, or other electronic connection.

In another embodiment, the communication between the policy approval module 350 and the approved policy database 360 may be through a network connection, Ethernet connection, internet connection, SQL connection, RF connection, infrared connection, wireless connection, photonic connection, or other electronic connection.

In another embodiment, the communication between the policy approval module 350 and the securities intermediary system 370 may be through a network connection, Ethernet connection, internet connection, file transfer protocol connection, RF connection, infrared connection, wireless connection, photonic connection, or other electronic connection.

In another embodiment, the communication between securities intermediary system 370 and the securities intermediary database 380 may be through a network connection, Ethernet connection, internet connection, SQL connection, RF connection, infrared connection, wireless connection, photonic connection, or other electronic connection.

In another embodiment, the communication between securities intermediary system 370 and the securities intermediary computer 385 may be through a network connection, Ethernet connection, internet connection, file transfer protocol connection, RF connection, infrared connection, wireless connection, photonic connection, or other electronic connection.

In another embodiment, the communication between securities intermediary system 370 and the member computer 310 may be through a network connection, Ethernet connection, internet connection, file transfer protocol connection, RF connection, infrared connection, wireless connection, photonic connection, or other electronic connection.

In another embodiment, the communication between the policy approval module 350 and the operations policy review computer 390 may be through a network connection, Ethernet connection, internet connection, file transfer protocol connection, RF connection, infrared connection, wireless connection, photonic connection, or other electronic connection.

In another embodiment, the data representing the access request sent from the member computer 310 may include a username and password.

In another embodiment, the data representing access request sent from the member computer 310 may include a username and PIN code.

In another embodiment, after the data representing the approval status of the senior life settlement policy has been entered into the securities intermediary database 380, the securities intermediary system 370 may generate data representing pre-populated owner change forms and pre-populated beneficiary change forms for execution by the member and the securities intermediary. The securities intermediary system 370 may then communicate the data representing pre-populated forms to the securities intermediary computer 385. The securities intermediary user may print these forms from the securities intermediary computer 385 to then send to the member who wishes to list the particular senior life settlement policy for auction. These forms must be signed by the member who wishes to list the particular policy to the insurance provider. After the member signs these forms, the member sends them to the securities intermediary, who also signs them. Then, the securities intermediary sends the signed forms to the insurance carrier, and the process proceeds generally as described above.

In another embodiment, after the data representing that the approval status of the policy is approved has been entered into the securities intermediary database 380, the securities intermediary system 370 may generate data representing pre-populated owner change forms and pre-populated beneficiary change forms. The securities intermediary system 370 may then communicate the data representing pre-populated forms to the member computer 310. The member computer 310 may receive the data representing pre-populated forms and may display them for the member. The member may then print these pre-populated forms, then sign them, and then send them to the securities intermediary, who must sign them and send them to the insurance carrier, and then the process proceeds generally as described above.

In another embodiment, after the member sends the senior life settlement policy and supporting documentation to the securities intermediary, the securities intermediary user may then scan or digitize the senior life settlement policy and supporting policy documentation to data representing the senior life settlement policy and supporting policy documentation using the securities intermediary computer 385. The securities intermediary user may then enter the data representing the scanned documentation into the securities intermediary computer 385. The securities intermediary computer 385 receives the data representing the scanned documentation and then may communicate it to the securities intermediary system 370. The securities intermediary system 370 receives the data representing the scanned documentation and then enters it into the securities intermediary database 380 where it is stored. The securities intermediary system 370 also then communicates the data representing the scanned documentation to the policy approval module 350. The policy approval module 350 receives the data representing the scanned documentation from the securities intermediary system 370 and then enters it into the approved policy database 360 where it is stored.

In another embodiment, the securities intermediary user may review data representing the scanned documentation on the securities intermediary computer 385 and may select the personal identifying information contained within the data representing the scanned documentation that is to be redacted. After the securities intermediary user has selected the personal identifying information that is to be redacted, the securities intermediary computer 385 redacts the selected personal identifying information. Then, the securities computer 385 sends data representing the redacted documentation, without the personal identifying data that has been redacted, to the securities intermediary system 370. The securities intermediary system 370 receives the data representing the redacted documentation and then enters it in the securities intermediary database 380 where it is stored. The securities intermediary system 370 then communicates the data representing the redacted documentation to the policy approval module 350. The policy approval module 350 receives the data representing the redacted documentation and then enters it into the approved policy database 360 where it is stored.

In another embodiment, an operations review user (not shown) may review data representing the senior life settlement policy and supporting policy documentation a through a web-based interface supported by the policy approval module 350 on the operations policy review computer 390 and may select the personal identifying information to be redacted. After the operations review user has selected the personal identifying information to be redacted, the operations policy review computer 390 redacts the selected personal identifying information. Then, the operations policy review computer 390 sends data representing the redacted documentation without the personal identifying information that has been redacted, to the policy approval module 350. The policy approval module 350 receives data representing the redacted documentation and then enters it in the approved policy database 360 where it is stored. The policy approval module 350 then communicates data representing the redacted documentation to the securities intermediary system 370. The securities intermediary system 370 receives the data representing the redacted documentation and then enters it into the securities intermediary database 380 where it is stored.

In another embodiment, the redaction of personal identifying information may be performed by a securities intermediary user (not shown). In another embodiment, the redaction of personal identifying information may be performed by an operations review user (not shown).

In another embodiment, if access to the policy approval module 350 is denied, the electronic notification sent to the member computer 310 that indicates that access to the policy approval module 350 was denied may be displayed in a web-based interface supported by the policy approval module 350 displayed on the member computer 310.

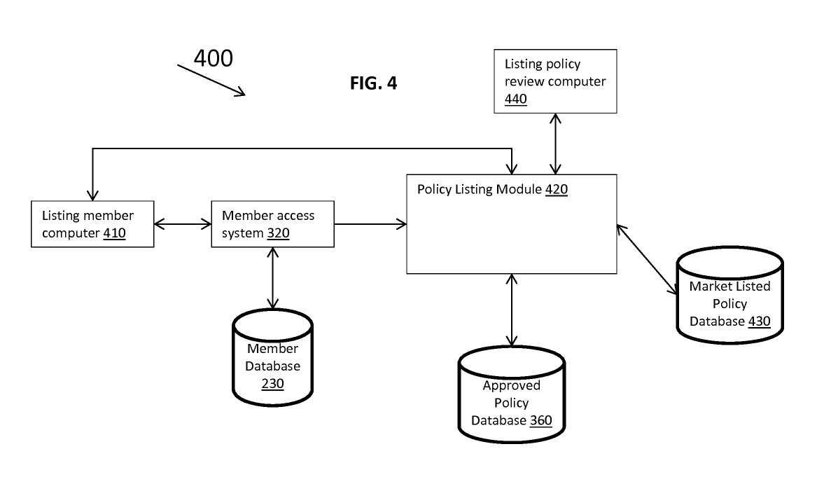

FIG. 4 is a block diagram illustrating an embodiment of the policy listing system 400 through which members list senior life settlement policies on the exchange system 100 for auction. Policy listing system 400 includes a listing member computer 410, the member access system 320, the member database 230, a policy listing module 420, the approved policy database 360, a market listed policy database 430, and a listing policy review computer 440.

The listing member computer 410 is in communication with the member access system 320 and the policy listing module 420. The member access system 320 is further in communication with the member database 230 and the policy listing module 420. The policy listing module 420 is further in communication with the approved policy database 360, the market listed policy database 430, and the listing policy review computer 440.

In operation, a listing member (not shown) may enter an access request into the listing member computer 410 for access to the policy listing module 420. The listing member computer 410 receives the access request and processes it to send data representing that access request to the member access system 320. The member access system 320 receives the data representing the access request from the listing member computer 410 and searches the member database 230 for data that corresponds to the data included in the access request. If member access system 320 finds data in the member database 230 that corresponds to the data included in the access request, then the member access system 320 allows the listing member computer 410 to communicate with the policy listing module 420. If member database 230 does not include data that corresponds to the data included in the access request sent from listing member computer 410, the member access system 320 does not allow the listing member computer 410 to access the policy listing module 420. If the member access system 320 does not allow the listing member computer 410 to communicate with the policy listing module 420, the access control system 320 sends an electronic notification to the listing member computer 410 to indicate that access to the policy listing module 420 was denied, where it is displayed.

If the member access system 320 allows the listing member computer 410 to communicate with the policy listing module 420, the listing member computer 410 may communicate with the policy listing module 420. Also, the member access system 320 may send to the policy listing module 420 data representing the identity of the member who wishes to access the policy listing module 420. The policy listing module 420 then queries the approved policy database 360 for at least some of the data representing senior life settlement policies that are associated with the listing member who has accessed the policy listing module 420 through the listing member computer 410 and that have been approved. The policy listing module 420 then communicates the retrieved data to the listing member computer 410 where it is displayed.

The listing member computer 410 receives as input a selection by the listing member of any senior life settlement policy that the listing member wishes to make available for auction. The listing member may then need to submit updated supporting policy documentation to the exchange system prior to making the policy available for auction. To submit updated supporting policy documentation, the listing member may scan the updated supporting policy documentation into the listing member computer 410 using a scanner (not shown). The listing member may then upload the data representing the updated supporting policy documentation to the policy listing module 420 through a web-based interface supported by the policy listing module 420. The policy listing module 420 receives the data representing the updated supporting policy documentation and stores it in the approved policy database 360.

Before a senior life settlement policy is made available for auction on exchange system 100, personal identifying information must be removed from any data representing any updated supporting policy documentation for the particular senior life settlement policy. The listing policy review computer 440 is used to redact personal identifying information from the data representing the updated supporting policy documentation. To do this, listing policy review user (not shown) enters a request to review at least some of the data representing the updated supporting policy documentation into the listing policy review computer 440. The listing policy review computer 440 sends the request to the policy listing module 420. The policy listing module 420 receives the request from the listing policy review computer 440 and then retrieves at least some of the data corresponding to the request from the approved policy database 360. After the policy listing module 420 retrieves the data corresponding to the request, the policy listing module 420 communicates the data to the listing policy review computer 440 where it is displayed.

The listing policy review user then reviews the received data representing updated supporting policy documentation on the listing policy review computer 440 and selects the personal identifying information that is to be redacted. After the listing policy review user has selected the personal identifying information that is to be redacted, the listing policy review computer 440 redacts the selected personal identifying information from the data representing the updated supporting policy documentation. Then, the listing policy review computer 440 sends the data representing the updated supporting policy documentation with personal identifying data redacted to the policy listing module 420. The policy listing module 420 receives the data representing the updated supporting policy documentation with personal identifying information redacted and then enters it in the approved policy database 360 where it is stored. After the data representing the updated supporting policy documentation with personal identifying information redacted has been stored in the approved policy database 360 by the policy listing module 420, the policy listing module 420 generates an electronic notification that is communicated to the listing member computer 410 indicating that the listing member may now enter dynamic policy data prior to making the policy available for auction on the exchange system 100.

After the policy listing module 420 has stored the data representing the updated supporting policy documentation with personal identifying information redacted in the approved policy database 360 and after the policy listing module 420 has sent the electronic notification to the listing member computer 410 indicating that the listing member may enter dynamic policy data, the listing member may input into the listing member computer 410 a selection of the senior life settlement policy for which the listing member wishes to enter dynamic policy data. After the listing member computer 410 has accepted as input the selection of a senior life settlement policy to be listed for auction, the listing member computer 410 also accepts as input dynamic policy data to be associated with senior life settlement policy selected by the listing member. The dynamic policy data may include, but is not intended to be limited to, auction start date, auction end date, reserve price (the minimum amount a bid must be for a successful auction), account value, account value date, reserve price date, surrender value, surrender value date, the following month's deductions for the cost of insurance, the name of the qualified securities intermediary, and an indicator representing whether the owner has paid all premiums on the policy to keep it in force and out of grace period for a period that is 30 days after the projected Settlement Date, date of last premium payment, amount of last premium payment, and the date through which the premiums have been paid. The listing member computer 410 then processes these inputs to communicate data identifying the selected senior life settlement policy and the associated dynamic policy data to the policy listing module 420. The policy listing module 420 receives the data identifying the selected senior life settlement policy and associated dynamic policy data from the listing member computer 410. The policy listing module 420 then communicates the data identifying the selected senior life settlement policy and associated dynamic policy data to the market listed policy database 430 where it is stored. The policy listing module 420 may then enter data representing the listing status of the policy in the approved policy database 360 to reflect that the policy is available for auction.

In another embodiment, the listing member computer 410 may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the listing member computer 410 and listing policy review computer 440 each may be a computing device such as a personal computer, laptop computer, personal digital assistant, smart phone, tablet computer, or other computing device.

In another embodiment, the member database 230 may be an electronic database.

In another embodiment, the approved policy database 360 may be an electronic database.

In another embodiment, the market listed policy database 430 may be an electronic database.

In another embodiment, the communication between the listing member computer 410 and the member access system 320 may be through a network connection, Ethernet connection, internet connection, file transfer protocol connection, RF connection, infrared connection, wireless connection, photonic connection, or other electronic connection.

In another embodiment, the communication between the member access system 320 and the member database 230 may be through a network connection, Ethernet connection, internet connection, SQL connection, RF connection, infrared connection, wireless connection, photonic connection, or other electronic connection.

In another embodiment, the communication between the member access system 320 and the policy listing module 420 may be through a network connection, Ethernet connection, internet connection, file transfer protocol connection, RF connection, infrared connection, wireless connection, photonic connection, or other electronic connection.

In another embodiment, the communication between the policy listing module 420 and the approved policy database 360 may be through a network connection, Ethernet connection, internet connection, SQL connection, RF connection, infrared connection, wireless connection, photonic connection, or other electronic connection.

In another embodiment, the communication between the policy listing module 420 and the market listed policy database 430 may be through a network connection, Ethernet connection, internet connection, SQL connection, RF connection, infrared connection, wireless connection, photonic connection, or other electronic connection.

In another embodiment, the communication between the policy listing module 420 and the listing member computer 410 may be through a network connection, Ethernet connection, internet connection, SQL connection, RF connection, infrared connection, wireless connection, photonic connection, or other electronic connection.

In another embodiment, the communication between the policy listing module 420 and the listing policy review computer 440 may be through a network connection, Ethernet connection, internet connection, SQL connection, RF connection, infrared connection, wireless connection, photonic connection, or other electronic connection.

In another embodiment, the policy listing module 420 may be a software program containing a set of instructions stored in at least one computer-readable medium that are executable to cause a system to perform operations based on the instructions.

In another embodiment, the policy listing module 420 may be stored on a server, a plurality of servers, a mobile server, a desktop computer, a workstation, a laptop computer, in a cloud computing network, or other similar computing device.

In another embodiment, the member access system 320 may be a software program containing a set of instructions stored in at least one computer-readable medium that are executable to cause a system to perform operations based on the instructions.

In another embodiment, the member access system 320 may be stored on a server, a plurality of servers, a mobile server, a desktop computer, a workstation, a laptop computer, in a cloud computing network, or other similar computing device.

In another embodiment, the data representing the access request sent from the listing member computer 410 may include a username and password.

In another embodiment, the data representing the access request sent from the listing member computer 410 may include a username and PIN code.

In another embodiment, the dynamic policy data entered by the listing user into the listing member computer 410 may include data indicating that an auction should be extended if no bid is equal to or higher than the reserve price, data representing the amount of time that the auction should be extended if no bid is equal to or higher than the reserve price, and data representing the amount by which the reserve price should be reduced if no bid received during the auction of said senior life settlement policy is equal to or higher than the reserve price. The listing member computer 410 may then communicate the dynamic policy data generally as described above to the policy listing module 420, including the data representing the number of days that the auction should be extended. The policy listing module 420 receives the dynamic policy data generally as described above, including the data representing the number of days that the auction should be extended. The policy listing module 420 then enters the dynamic policy data into the market listed policy database 430 generally as described above, including the data representing the number of days that the auction should be extended.

In another embodiment, the access request entered by the listing user into a web-based interface supported by the member access system 320 displayed on the listing member computer 410.

In another embodiment, if access to the policy listing module 420 is denied, the electronic notification sent to the listing member computer 410 that indicates that access to the policy listing module 420 was denied may be displayed in a web-based interface supported by the member access system 320 displayed on the listing member computer 410.

In another embodiment, the data representing senior life settlement policies that are owned by the listing member who has accessed the policy listing module 420 may be displayed in a web-based interface supported by the policy listing module 420 displayed on the listing member computer 410.

In another embodiment, the selection by the listing member of any senior life settlement policies that the listing member wishes to make available for auction may be entered into a web-based interface supported by the policy listing module 420 displayed on the listing member computer 410.

In another embodiment, the selection by the listing member of any senior life settlement policies that the listing member wishes to make available for auction may be made by clicking a hyperlink representing the senior life settlement policy in a web-based interface supported by the policy listing module 420 displayed on listing member computer 410.

In another embodiment, the selection by the listing member of any senior life settlement policies that the listing member wishes to make available for auction may be made by selecting a radio button next to the policy or policies in a web-based interface supported by the policy listing module 420 displayed on the listing member computer 410.

In another embodiment, the selection by the listing member of any senior life settlement policies that the listing member wishes to make available for auction may be made by selecting a check box next to the policy or policies in a web-based interface supported by the policy listing module 420 displayed on the listing member computer 410.

In another embodiment, the selection by the listing member of any senior life settlement policies that the listing member wishes to make available for auction may be made by selecting the policies or policies from a pre-populated drop down list of policies in a web-based interface supported by the policy listing module 420 displayed on the listing member computer 410.

In another embodiment, the dynamic policy data may be entered as text into a web-based interface supported by the policy listing module 420 displayed on the listing member computer 410.

In another embodiment, the dynamic policy data may be entered by the listing member selecting the desired values from pre-populated drop down lists in a web-based interface supported by the policy listing module 420 displayed on the listing member computer 410.

In another embodiment, if the listing member does not input into the listing member computer 410 any data representing the amount of time that the auction should be extended if no bid is equal to or higher than the reserve price or data representing the amount by which the reserve price should be reduced if no bid received during the auction of said senior life settlement policy is equal to or higher than the reserve price, then the policy listing module 420 may set default values for this data and communicate those default values to the market listed policy database 430 where those default values are stored.

In another embodiment, the listing member may input into a web-based interface supported by the policy listing module 420 displayed on the listing member computer 410 a selection of multiple senior life settlement policies to be offered for auction together.

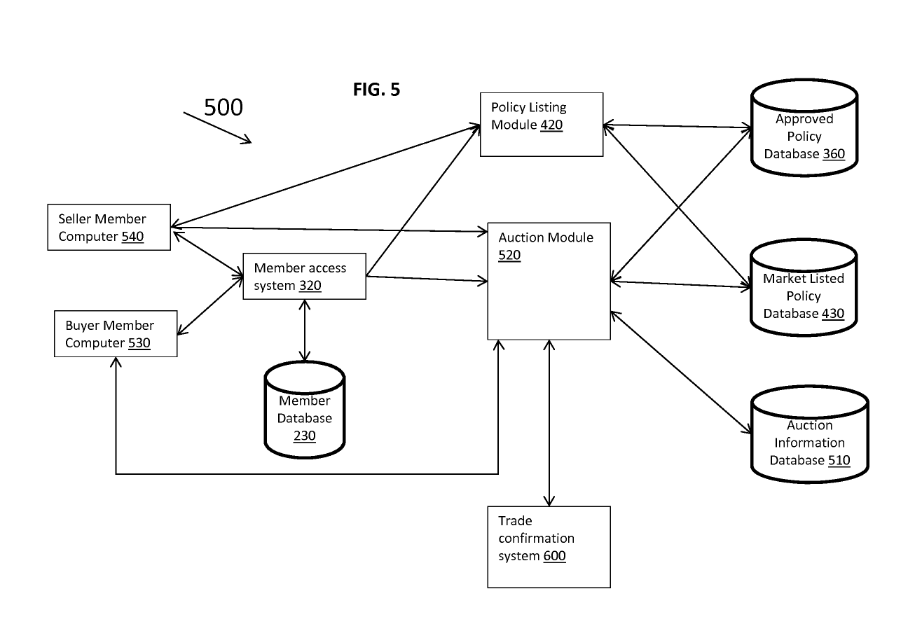

FIG. 5 is a block diagram illustrating an embodiment of the auction system 500 through which the live auction of senior life settlement policies takes place. Auction system 500 includes an auction information database 510, the approved policy database 360, an auction module 520, the market listed policy database 430, the member access system 320, the member database 230, a buyer member computer 530, a seller member computer 540, the trade confirmation system 600, and the policy listing module 420.

The approved policy database 360 is in communication with the auction module 520 and the policy listing module 420. The auction information database 510 is in communication with the auction module 520. The auction module 520 is also in communication with the market listed policy database 430, the member access system 320, the buyer member computer 530, the seller member computer 540, and the trade confirmation system 600. The member access system 320 is in communication with the member database 230, the buyer member computer 530, the seller member computer 540, and the policy listing module 420. The seller member computer 540 is further in communication with the policy listing module 420. The policy listing module 420 is further in communication with the market listed policy database 430.

In operation, a buyer member (not shown) may enter an access request into the buyer member computer 530 for access to auction module 520. The buyer member computer 530 receives the access request and processes it to send data representing that access request to the member access system 320. The member access system 320 receives the access request from the buyer member computer 530 and searches the member database 230 for data that corresponds to the data included in the access request. If member access system 320 finds data in member database 230 that corresponds to the data included in the access request, then the member access system 320 allows the buyer member computer 530 to communicate with auction module 520. If member database 230 does not include data that corresponds to the data included in the access request sent from buyer member computer 530, the member access system 320 does not allow the buyer member computer 530 to communicate with the auction module 520. If the member access system 320 does not allow the buyer member computer 530 to communicate with the auction module 520, the access control system 320 sends an electronic notification to the buyer member computer 530 to indicate that access to the auction module 520 was denied, where the electronic notification is displayed.

If the member access system 320 allows the buyer member computer 530 to communicate with the auction module 520, the buyer member computer 530 may communicate with the auction module 520. The buyer member computer 530 may accept as input data representing a request from the buyer member to view data representing senior life settlement policies that are available for auction that include certain data, for example, query parameters. The buyer member computer 530 communicates the data representing the request from the buyer to the auction module 520. The auction module 520 receives the data representing the request from the buyer member computer 530 and then uses that data to query the approved policy database 360 to determine if any data representing senior life settlement policies available for auction is stored in the approved policy database 360 matches the data representing the request. If there is a match, the auction module 520 then retrieves the data representing the listing status of the senior life settlement policy from the approved policy database 360 to determine if the senior life settlement policy is available for auction. If the data representing the listing status of the senior life settlement policy indicates that the senior life settlement policy is available for auction, the auction module 520 retrieves at least some of the data representing the senior life settlement policy from the approved policy database 360 which is then communicated to the buyer member computer 530 where it is displayed. The auction module 520 also retrieves the data representing bid history associated with that particular senior life settlement policy from the auction information database 510 and communicates that data to the buyer member computer 530 where it is displayed. If there is not a match or if the data representing the listing status of the policy indicates that the policy is not available for auction, the auction module 520 generates an electronic notification indicating that there are no policies available for auction that match the query parameters, and that electronic notification is communicated to the buyer member computer 530 where it is displayed.

If there is a policy, or block of policies offered for auction together, available for auction on which the buyer member wishes to place a bid, the buyer member inputs into the buyer member computer 530 a selection of a senior life settlement policy, or a block of senior life settlement policies offered for auction together, on which a buyer member wishes to enter a bid. The buyer member computer 530 also may accept as input a bid amount for the senior life settlement policy selected by the buyer member. The buyer member computer 530 processes those inputs and communicates data representing the identity of the selected senior life settlement policy or block of policies and bid amount to the auction module 520. The auction module 520 receives the data identifying the senior life settlement policy and bid amount. The auction module 520 then queries the auction information database 510 for data representing the highest bid amount associated with the selected senior life settlement policy. The auction module 520 receives the data representing the highest bid amount for the selected senior life settlement policy from the auction information database 510 and compares it to the data representing the bid amount received from the buyer member computer 530. If the comparison by the auction module 520 indicates that the bid amount received from the buyer member computer 530 is greater than the highest bid amount from the auction information database 510, then the auction module 520 enters the bid amount received from the buyer member computer 530 into the auction information database 510 as the new highest bid amount.

If the comparison by the auction module 520 indicates that the bid amount received is equal to or less than the highest bid amount associated with the selected senior life settlement policy retrieved from the auction information database 510, then the auction module 520 generates an electronic notification that the bid amount received from the buyer member computer 530 is too low. The auction module 520 then communicates the electronic notification to the buyer member computer 530 where it is displayed.

When the auction has ended or a particular senior life settlement policy has expired, the auction module 520 determines whether a trade occurred or not. To determine whether the auction for a particular senior life settlement policy has ended, the auction module 520 retrieves data representing the auction end date associated with a particular policy from the market listed policy database 430. The auction system 520 then compares data representing the current date to the data representing the auction end date that was retrieved from the market listed policy database 430. If the comparison indicates that the current date is earlier than the auction end date, then the auction module 520 determines that the auction period is still open and generates an indicator that said auction period is still open which is communicated to said auction information database 510 where it is stored.

If the comparison indicates that the current date is equal to or later than the auction end date, then the auction module 520 determines that the auction end date has passed and the auction period has ended and generates an indicator that said auction period is closed which is communicated to said auction information database 510 where it is stored. After the auction module 520 has generated the indicator that the auction period has ended, the auction module 520 queries the auction information database 510 to retrieve the data representing the highest bid amount stored in the auction information database 510 for that particular senior life settlement policy, and the auction module 520 queries the market listed policy database 430 to retrieve data representing the reserve price associated with that particular senior life settlement policy. The auction module 520 then receives the data representing the highest bid amount from the auction information database 510 and the data representing the reserve price from the market listed policy database 430. The auction module 520 then compares data representing the highest bid amount to the data representing the reserve price for that particular senior life settlement policy. If the comparison by the auction module 520 indicates that the highest bid amount is equal to or greater than the reserve price, then the auction module 520 determines that the auction was successful and generates an indicator that the auction was successful that is communicated to the auction information database 510 where it is stored. The auction module 520 additionally generates an electronic notification that is communicated to the trade confirmation module 620 in the trade confirmation system 600, which is described below.

If the comparison indicates that the highest bid amount is less than the reserve price, then the auction module 520 determines that the auction was not successful and generates an indicator that the auction was not successful and communicates that indicator to the auction information database 510 where it is stored. After the auction module 520 has generated the indicator that the auction was not successful, the auction module 520 queries the market listed policy database 430 for data representing whether the auction should be extended for that particular senior life settlement policy. If the auction module 520 retrieves data indicating that the auction should be extended for that particular senior life settlement policy, then the auction module 520 retrieves data representing the amount of time that the auction should be extended, processes that data to determine the new auction end date, and communicates to the market listed policy database 430 the new auction end date associated with that particular senior life settlement policy.

In another embodiment, if the auction module 520 retrieves data indicating that the auction should be extended for that particular senior life settlement policy, the auction module 520 then retrieves from the market listed policy database 430 the amount by which the reserve price is to be decreased for the particular senior life settlement policy. The auction module 520 then processes the retrieved data to determine the new reserve price for the particular policy, and the auction module 520 enters the new reserve price into the market listed policy database 430.

At any point during an auction period for a particular senior life settlement policy, the selling member who put the policy up for auction may change the dynamic policy data associated with that particular policy. The seller member (not shown) may enter an access request into the seller member computer 540 for access to the policy listing module 420. The seller member computer 540 receives the access request and processes it to send data representing that access request to the member access system 320. The seller member computer 540 then sends the data representing the access request to the member access system 320. The member access system 320 receives the data representing the access request from the seller member computer 540 and searches the member database 230 for data that corresponds to the data included in the access request. If member access system 320 finds data in the member database 230 that corresponds to the data included in the access request, then the member access system 320 allows the seller member computer 540 to communicate with the policy listing module 420. If member database 230 does not include data that corresponds to the data included in the access request sent from seller member computer 540, the member access system 320 does not allow the seller member computer 540 to access the policy listing module 420. If the member access system 320 does not allow the seller member computer 540 to communicate with the policy listing module 420, the access control system 320 sends an electronic notification to the seller member computer 540 to indicate that access to the policy listing module 420 was denied, where the electronic notification is displayed.

If the member access system 320 allows the seller member computer 540 to communicate with the policy listing module 420, the seller member computer 540 may communicate with the policy listing module 420. Also, the member access system 320 will send to the policy listing module 420 data representing the identity of the member who wishes to access the policy listing module 420. The policy listing module 420 then queries the approved policy database 360 for data representing senior life settlement policies that are associated with the seller member who has accessed the policy listing module 420 through the seller member computer 540 and that have been approved. The policy listing module 420 then communicates at least some of the data representing senior life settlement policies associated with the seller member who has accessed the policy listing module 420 to the seller member computer 540 where it is displayed.

The seller member computer 540 receives as input a selection by the seller member of any senior life settlement policies for which the seller member wishes to change the dynamic policy data. After the seller member computer 540 has accepted as input the selection of a senior life settlement policy for which the seller member wishes to update the dynamic policy data, the seller member computer 540 also accepts as input the new dynamic policy data to be associated with the selected senior life settlement policy. The seller member computer 540 then processes those inputs and communicates to the policy listing module 420 the data identifying the selected senior life settlement policy and data representing the new dynamic policy data. The policy listing module 420 receives the data identifying the selected senior life settlement policy and data representing the new dynamic policy data from the seller member computer 540. The policy listing module 420 then communicates the data identifying the selected senior life settlement policy and data representing the new dynamic policy data to the market listed policy database 430 where it is stored.

In another embodiment, the seller member computer 540 and buyer member computer 530 each may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the buyer member computer 530 may be a computing device such as a personal computer, laptop computer, personal digital assistant, smart phone, tablet computer, or other computing device.

In another embodiment, the seller member computer 540 may be a computing device such as a personal computer, laptop computer, personal digital assistant, smart phone, tablet computer, or other computing device.

In another embodiment, the member database 230 may be an electronic database.

In another embodiment, the approved policy database 360 may be an electronic database.

In another embodiment, the market listed policy database 430 may be an electronic database.

In another embodiment, the auction information database 510 may be an electronic database.

In another embodiment, the auction module 520 may be a software program containing a set of instructions stored in at least one computer-readable medium that are executable to cause a system to perform operations based on the instructions.

In another embodiment, the auction module 520 may be stored on a server, a plurality of servers, a mobile server, a desktop computer, a workstation, a laptop computer, in a cloud computing network, or other similar computing device.

In another embodiment, the member access system 320 may be a software program containing a set of instructions stored in at least one computer-readable medium that are executable to cause a system to perform operations based on the instructions.

In another embodiment, the member access system 320 may be stored on a server, a plurality of servers, a mobile server, a desktop computer, a workstation, a laptop computer, in a cloud computing network, or other similar computing device.

In another embodiment, the policy listing module 420 may be a software program containing a set of instructions stored in at least one computer-readable medium that are executable to cause a system to perform operations based on the instructions.

In another embodiment, the policy listing module 420 may be stored on a server, a plurality of servers, a mobile server, a desktop computer, a workstation, a laptop computer, in a cloud computing network, or other similar computing device.

In another embodiment, after the member access system 320 allows the buyer member computer 530 to communicate with the auction module 520, the auction module 520 may retrieve data representing the senior life settlement policies currently available for auction from the market listed policy database 430 and may communicate that data to the buyer member computer 530 where it is displayed.

In another embodiment, the communication between the seller member computer 540 and member access system 320 may be through a network connection, Ethernet connection, internet connection, file transfer protocol connection, RF connection, infrared connection, wireless connection, photonic connection, or other electronic connection.

In another embodiment, the communication between the buyer member computer 530 and member access system 320 may be through a network connection, Ethernet connection, internet connection, file transfer protocol connection, RF connection, infrared connection, wireless connection, photonic connection, or other electronic connection.

In another embodiment, the communication between the seller member computer 540 and policy listing module 420 may be through a network connection, Ethernet connection, internet connection, file transfer protocol connection, RF connection, infrared connection, wireless connection, photonic connection, or other electronic connection.

In another embodiment, the communication between the seller member computer 540 and auction module 520 may be through a network connection, Ethernet connection, internet connection, file transfer protocol connection, RF connection, infrared connection, wireless connection, photonic connection, or other electronic connection.

In another embodiment, the communication between the member access system 320 and auction module 520 may be through a network connection, Ethernet connection, internet connection, file transfer protocol connection, RF connection, infrared connection, wireless connection, photonic connection, or other electronic connection.

In another embodiment, the communication between the member access system 320 and the policy listing module 420 may be through a network connection, Ethernet connection, internet connection, file transfer protocol connection, RF connection, infrared connection, wireless connection, photonic connection, or other electronic connection.

In another embodiment, the communication between the buyer member computer 530 and auction module 520 may be through a network connection, Ethernet connection, internet connection, file transfer protocol connection, RF connection, infrared connection, wireless connection, photonic connection, or other electronic connection.

In another embodiment, the communication between the auction module 520 and trade confirmation system 600 may be through a network connection, Ethernet connection, internet connection, file transfer protocol connection, RF connection, infrared connection, wireless connection, photonic connection, or other electronic connection.

In another embodiment, the communication between the member access system 320 and member database 230 may be through a network connection, Ethernet connection, internet connection, SQL connection, RF connection, infrared connection, wireless connection, photonic connection, or other electronic connection.

In another embodiment, the communication between the policy listing module 420 and approved policy database 360 may be through a network connection, Ethernet connection, internet connection, SQL, connection, RF connection, infrared connection, wireless connection, photonic connection, or other electronic connection.

In another embodiment, the communication between the policy listing module 420 and market listed policy database 430 may be through a network connection, Ethernet connection, internet connection, SQL connection, RF connection, infrared connection, wireless connection, photonic connection, or other electronic connection.

In another embodiment, the communication between the auction module 520 and approved policy database 360 may be through a network connection, Ethernet connection, internet connection, SQL connection, RF connection, infrared connection, wireless connection, photonic connection, or other electronic connection.

In another embodiment, the communication between the auction module 520 and market listed policy database 430 may be through a network connection, Ethernet connection, internet connection, SQL connection, RF connection, infrared connection, wireless connection, photonic connection, or other electronic connection.

In another embodiment, the communication between the auction module 520 and auction information database 510 may be through a network connection, Ethernet connection, internet connection, SQL connection, RF connection, infrared connection, wireless connection, photonic connection, or other electronic connection.

In another embodiment, data representing the number of days that the auction should be extended if the auction for the particular senior life settlement policy is not successful may be entered into the market listed policy database 430, then when the auction closes for that particular senior life settlement policy, and if the highest bid amount is equal to or less than the reserve price, then the auction module 520 queries the market listed policy database 430 for the data representing the number of days that the auction should be extended if the auction for the particular senior life settlement policy is not successful. The auction module 520 retrieves data representing the number of days the auction should be extended, processes it by adding it to the current date value to generate a new auction end date, and then enters data representing a new auction end date into the market listed policy database 430.

In another embodiment, the access request sent by the buyer member computer 530 may include a username and password.

In another embodiment, the access request sent by the buyer member computer 530 may include a username and PIN code.

In another embodiment, the access request sent by the seller member computer 540 may include a username and password.

In another embodiment, the access request sent by the seller member computer 540 may include a username and PIN code.

In another embodiment, the access request entered by the buyer member into a web-based interface supported by the member access system 320 displayed on the buyer member computer 530.

In another embodiment, the access request entered by the seller member into a web-based interface supported by the member access system 320 displayed on the seller member computer 540.

In another embodiment, if access to the auction module 520 is denied, the electronic notification sent to the buyer member computer 530 that indicates that access to the auction module 520 was denied may be displayed in a web-based interface supported by the member access system 320 displayed on the buyer member computer 530.

In another embodiment, if access to the policy listing module 420 is denied, the electronic notification sent to the seller member computer 540 that indicates that access to the policy listing module 420 was denied may be displayed in a web-based interface supported by the member access system 320 displayed on the seller member computer 540.

In another embodiment, the seller member computer 540 may access the auction module 520 and the seller member (not shown) may view data associated with an auction of any policy associated with the seller member.

In another embodiment, the query parameters entered by the buyer member into the buyer member computer 530 may be entered as text into a web-based interface supported by the auction module 520 displayed on the buyer member computer 530.

In another embodiment, data retrieved by the auction module 520 from the approved policy database 360 about senior life settlement policies available for auction may be displayed through a web-based interface supported by the auction module 520 displayed on the buyer member computer 530.

In another embodiment, data retrieved by the auction module 520 from the approved policy database 360 about senior life settlement policies available for auction may be displayed through a web-based interface supported by the auction module 520 displayed on the seller member computer 540.

In another embodiment, the electronic notification sent from the auction module 520 indicating that there are no policies available for auction may be displayed through a web-based interface supported by the auction module 520 displayed on the buyer member computer 530.

In another embodiment, the selection by the buyer member of any senior life settlement policies for which the buyer member wishes to enter a bid may be entered into a web-based interface supported by the auction module 520 displayed on the buyer member computer 530.

In another embodiment, the selection by the buyer member of any senior life settlement policies for which the buyer member wishes to enter a bid may be made by the buyer clicking a hyperlink representing the senior life settlement policy in a web-based interface supported by the auction, module 520 displayed on buyer member computer 530.

In another embodiment, the selection by the buyer member of any senior life settlement policies for which the buyer member wishes to enter a bid may be made by the buyer member selecting a radio button next to the policy or policies in a web-based interface supported by the auction module 520 displayed on the buyer member computer 530.

In another embodiment, the selection by the buyer member of any senior life settlement policies for which the buyer member wishes to enter a bid may be made by the buyer member selecting a check box next to the policy or policies in a web-based interface supported by the auction module 520 displayed on the buyer member computer 530.

In another embodiment, the selection by the buyer member of any senior life settlement policies for which the buyer member wishes to enter a bid may be made by the buyer member selecting the policies or policies from a pre-populated drop-down list of policies in a web-based interface supported by the auction module 520 displayed on the buyer member computer 530.

In another embodiment, the bid amount entered by the buyer member into the buyer member computer 530 may be entered as text into a web-based interface supported by the auction module 520 displayed on the buyer member computer 530.

In another embodiment, the bid amount entered by the buyer member into the buyer member computer 530 may be entered by the buyer member selecting a value from a pre-populated drop down list in web-based interface supported by the auction module 520 displayed on the buyer member computer 530.

In another embodiment, the bid history associated with a particular senior life settlement policy may be displayed in a web-based interface supported by the auction module 520 displayed on the buyer member computer 530.

In another embodiment, the bid history associated with a particular senior life settlement policy may be displayed in a web-based interface supported by the auction module 520 displayed on the seller member computer 540.

In another embodiment, the electronic notification that the bid amount received from the buyer member computer 530 is too low may be displayed in a web-based interface supported by the auction module 520 displayed on the buyer member computer 530.

In another embodiment, the dynamic policy data entered by the seller member into the seller member computer 540 may include an indicator that an auction should be extended if no bid is high enough and the number of days that the auction should be extended if the auction for the particular senior life settlement policy is not successful. In this embodiment, the seller member computer 540 receives these inputs, processes them, and communicates data representing the dynamic policy data generally as described above to the policy listing module 420, including the data representing the number of days that the auction should be extended. The policy listing module 420 receives the dynamic policy data generally as described above, including the data representing the number of days that the auction should be extended. The policy listing module 420 then enters the dynamic policy data into the market listed policy database 430 generally as described above, including the data representing the number of days that the auction should be extended.

In another embodiment, the data representing senior life settlement policies that are associated with the seller member who has accessed the policy listing module 420 may be displayed in a web-based interface supported by the policy listing module 420 displayed on the seller member computer 540.

In another embodiment, the selection by the seller member of any senior life settlement policies for which the seller member wishes to change the dynamic policy data may be entered into a web-based interface supported by the policy listing module 420 displayed on the seller member computer 540.

In another embodiment, the selection by the seller member of any senior life settlement policies for which the seller member wishes to change the dynamic policy data may be made by the seller member clicking on a hyperlink representing the senior life settlement policy in a web-based interface supported by the policy listing module 420 displayed on the seller member computer 540.

In another embodiment, the selection by the seller member of any senior life settlement policies for which the seller member wishes to change the dynamic policy data may be made by the seller member selecting a radio button next to the policy or policies in a web-based interface supported by the policy listing module 420 displayed on the seller member computer 540.

In another embodiment, the selection by the seller member of any senior life settlement policies for which the seller member wishes to change the dynamic policy data may be made by the seller member selecting a check box next to the policy or policies displayed in a web-based interface supported by the policy listing module 420 displayed on the seller member computer 540.

In another embodiment, the selection by the seller member of any senior life settlement policies for which the seller member wishes to change the dynamic policy data may be made by the seller member selecting the policies or policies from a pre-populated drop down list of policies in a web-based interface supported by the policy listing module 420 displayed on the seller member computer 540.

In another embodiment, the dynamic policy data may be entered as text into a web-based interface supported by the policy listing module 420 displayed on the seller member computer 540.

In another embodiment, the dynamic policy data may be entered by the seller member selecting the desired values from pre-populated drop down lists in a web-based interface supported by the policy listing module 420 displayed on the seller member computer 540.

In another embodiment, the buyer member computer 530 receives as input a request to view the senior life settlement policy or any supporting documentation associated with a senior life settlement policy with personal identifying information removed that is available for auction. The buyer member computer 530 then processes that input to communicate data representing the request by the buyer member to the auction module 520. The auction module 520 receives the data representing the request to view the senior life settlement policy or any supporting documentation with personal identifying information removed associated with a senior life settlement policy that is available for auction from the buyer member computer 530. The auction module 520 then processes the data representing the request to view the senior life settlement policy or any supporting documentation associated with a senior life settlement policy with personal identifying information removed to determine what data needs to be retrieved from the approved policy database 360. The auction module 520 then queries the approved policy database 360 to retrieve the requested data representing the senior life settlement policy or any supporting documentation with personal identifying information removed from the approved policy database 360. The auction module 520 then processes the retrieved data representing the senior life settlement policy or any supporting documentation with personal identifying information removed to make it viewable by the buyer member. After the auction module 520 has retrieved the data representing the senior life settlement policy or any supporting documentation with personal identifying information removed and processed it into a viewable format, the auction module communicates the data representing the senior life settlement policy or any supporting documentation, with personal identifying information removed to the buyer member computer 530 where it is displayed.

In another embodiment, the data representing the senior life settlement policy or any supporting documentation with personal identifying information removed that is sent to the buyer member computer 530 may be viewed in a web-based interface supported by the auction module 520 displayed on the buyer member computer 530.

In another embodiment, the data representing the senior life settlement policy or any supporting documentation with personal identifying information removed that is sent to the buyer member computer 530 may be viewed in PDF format on the buyer member computer 530.

In another embodiment, the buyer member enters his or her request to view data representing data representing the senior life settlement policy or any supporting documentation with personal identifying information removed into the buyer member computer 530 by clicking a button in a web-based interface supported by the auction module 520 displayed on the buyer member computer 530.

In another embodiment, the buyer member enters his or her request to view data representing data representing the senior life settlement policy or any supporting documentation with personal identifying information removed into the buyer member computer 530 by clicking a hyperlink in a web-based interface supported by the auction module 520 displayed on the buyer member computer 530.

In another embodiment, the buyer member enters his or her request to view data representing data representing the senior life settlement policy or any supporting documentation with personal identifying information removed into the buyer member computer 530 by selecting from a drop-down list in a web-based interface supported by the auction module 520 displayed on the buyer member computer 530.

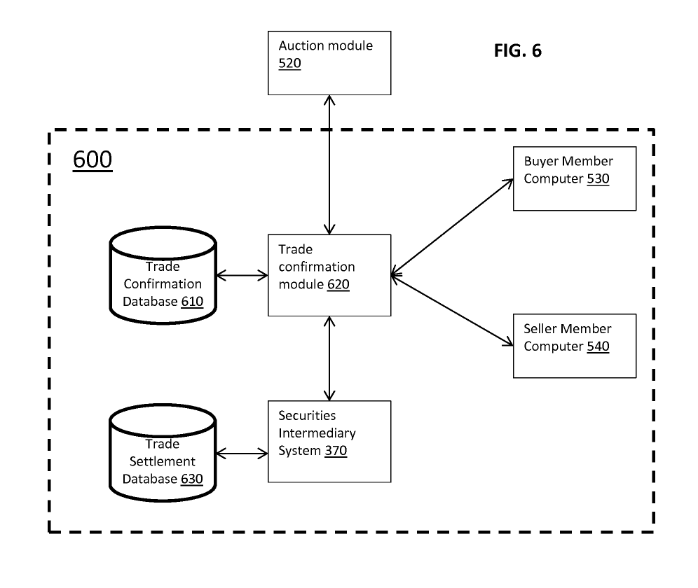

FIG. 6 is a block diagram illustrating an embodiment of the trade confirmation system 600. Trade confirmation system 600 includes a trade confirmation database 610, a trade confirmation module 620, the securities intermediary system 370, a trade settlement database 630, the buyer member computer 530, and the seller member computer 540.

The trade confirmation module 620 is in communication with the auction module 520 (described above), the trade confirmation database 610, the buyer member computer 530, the seller member computer 540, and the securities intermediary system 370. The securities intermediary system 370 is also in communication with the trade settlement database 630.

In operation, when a trade has occurred, the auction module 520 in the auction system 500 sends an electronic notification to the trade confirmation module 620 in the trade confirmation system 600. The electronic notification may include at least data indicating that an auction or trade was successful, data identifying the senior life settlement policy that was auctioned or traded, data representing the date of the auction or trade, data representing the identity of the buyer member, data representing the identity of the seller member, and data representing the amount of the auction or trade. The trade confirmation module 620 receives the electronic notification from the auction module 520 that a trade has occurred, and then the trade confirmation system 620 inputs the data included in the electronic notification into the trade confirmation database 610. The trade confirmation module 620 also generates an electronic notification that is sent to the securities intermediary system 370 that includes at least data indicating that an auction was successful, data identifying the policy that was traded, data representing the date of the auction, data representing the identity of the buyer member, data representing the identity of the seller member, and data representing an auction amount. The securities intermediary system 370 receives the data from the trade confirmation module 620 and inputs the data into the trade settlement database 630.

Because settlement of all auctions on the exchange system 100 should be done within three business days (T+3), the securities intermediary should settle the transaction within three business days of the date of auction. After the securities intermediary has settled the transaction within three business days, data indicating that settlement was completed within three business days and data representing the settlement date is entered into the securities intermediary system 370 by a securities intermediary user (not shown). The securities intermediary system 370 receives that data and enters it into the trade settlement database 630. The securities intermediary system 370 also generates an electronic settlement notification that is sent to the trade confirmation module 620 that includes data representing that the transaction (auction) has been settled and data representing the settlement date. The trade confirmation module 620 receives the data representing that the transaction has been settled and the data representing the settlement date from the securities intermediary system 370 and communicates that data into the trade confirmation database 610. The trade confirmation module 620 then retrieves the identity of the buying member and selling member for the particular transaction from the trade confirmation database 610. The trade confirmation module 620 then generates an electronic message that is sent to the buyer member computer 530 that the transaction has been settled by the securities intermediary, where the message is displayed, and an electronic message that is sent to the seller member computer 540 that the transaction has been settled by the securities intermediary, where the message is displayed.

In another embodiment, the buyer member computer 530 and seller member computer 540 each may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the buyer member computer 530 may be a computing device such as a personal computer, laptop computer, personal digital assistant, smart phone, tablet computer, or other computing device.

In another embodiment, the seller member computer 540 may be a computing device such as a personal computer, laptop computer, personal digital assistant, smart phone, tablet computer, or other computing device.

In another embodiment, the trade confirmation database 610 may be an electronic database.

In another embodiment, the trade settlement database 630 may be an electronic database.

In another embodiment, the trade confirmation module 620 may be a software program containing a set of instructions stored in at least one computer-readable medium that are executable to cause a system to perform operations based on the instructions.

In another embodiment, the trade confirmation module 620 may be stored on a server, a plurality of servers, a mobile server, a desktop computer, a workstation, a laptop computer, in a cloud computing network, or other similar computing device.

In another embodiment, the securities intermediary system 370 may be a software program containing a set of instructions stored in at least one computer-readable medium that are executable to cause a system to perform operations based on the instructions.

In another embodiment, the communication between the auction module 520 and trade confirmation module 620 may be through a network connection, Ethernet connection, internet connection, RF connection, infrared connection, wireless connection, photonic connection, or other electronic connection.

In another embodiment, the communication between the trade confirmation module 620 and buyer member computer 530 may be through a network connection, Ethernet connection, internet connection, RF connection, infrared connection, wireless connection, photonic connection, or other electronic connection.

In another embodiment, the communication between the trade confirmation module 620 and seller member computer 540 may be through a network connection, Ethernet connection, internet connection, RF connection, infrared connection, wireless connection, photonic connection, or other electronic connection.

In another embodiment, the communication between the trade confirmation module 620 securities intermediary system 370 may be through a network connection, Ethernet connection, internet connection, RF connection, infrared connection, wireless connection, photonic connection, or other electronic connection.

In another embodiment, the communication between the trade confirmation module 620 and trade confirmation database 610 may be through a network connection, Ethernet connection, internet connection, SQL connection, RF connection, infrared connection, wireless connection, photonic connection, or other electronic connection.

In another embodiment, the communication between the securities intermediary system 370 and trade settlement database 630 may be through a network connection, Ethernet connection, internet connection, SQL connection, RF connection, infrared connection, wireless connection, photonic connection, or other electronic connection.

In another embodiment, the securities intermediary system 370 may be stored on a server, a plurality of servers, a mobile server, a desktop computer, a workstation, a laptop computer, in a cloud computing network, or other similar computing device.

In another embodiment, the electronic notification sent by the trade confirmation module 620 to the buyer member computer 530 indicating that the transaction was settled may be displayed through a web-based interface supported by the trade confirmation module 620 displayed on the buyer member computer 530.

In another embodiment, the electronic notification sent by the trade confirmation module 620 to the seller member computer 540 indicating that the transaction was settled may be displayed through a web-based interface supported by the trade confirmation module 620 displayed on the seller member computer 540.

In one or more embodiments, the member creation module 220, login credentials transmission system 280, member access system 320, policy approval module 350, securities intermediary system 370, policy listing module 420, auction module 520, trade confirmation module 620, elective services module 720, and report module 1320 may reside on one or more computers or servers. In embodiments with more than one computer or server, the computers or servers may be in communication with each other, such as through a network.

In one or more embodiments, each of the member creation module 220, login credentials transmission system 280, member access system 320, policy approval module 350, securities intermediary system 370, policy listing module 420, auction module 520, trade confirmation module 620, elective services module 720, and report module 1320 may be stored in at least one computer-readable medium and may include instructions that are executable to cause a system to perform operations consistent with the instructions.

In one or more embodiments, the member database 230, approved policy database 360, securities intermediary database 380, market listed policy database 430, auction information database 510, trade confirmation database 610, trade settlement database 630, report database 730, and policy servicing database 740 may reside on one or more computers or servers. In embodiments with more than one computer or server, the computers or servers may be in communication with each other, such as through a network.

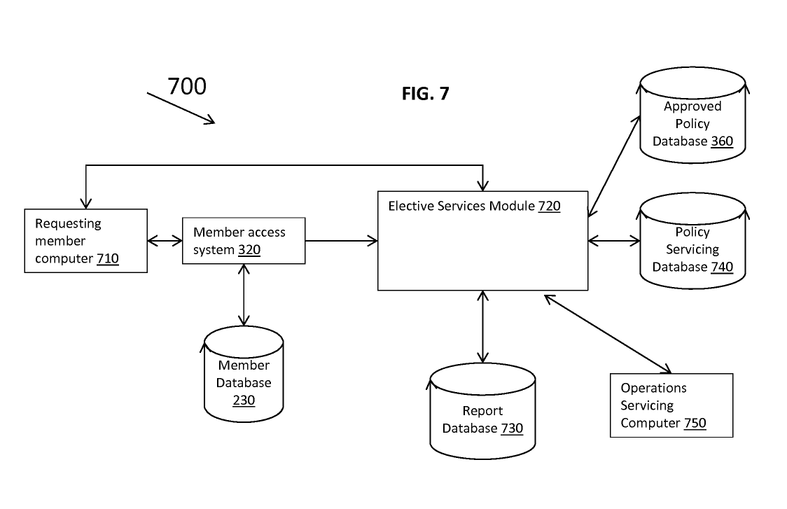

FIG. 7 is a block diagram illustrating an embodiment of an elective services system 700 through which members may request elective services. There are two types of elective services that may be requested. The first type of elective service may be policy servicing, whereby the member may request that the exchange pay the premiums on an underlying life insurance policy to ensure that it remains in force while it is being made available for auction. The second type of elective service may be allowing a member to order reports from third parties, whereby the member may obtain reports such as life expectancy reports, medical reports, mortality reports, a background check, a report including the net worth of an underlying insured individual, premium source check, verification of coverage, and updated senior life settlement documentation, or other reports that the member may find useful in deciding whether to bid on a senior life settlement policy available for auction. Elective services system 700 may include a requesting member computer 710, the member access system 320, the member database 230, an elective services module 720, a report database 730, a policy servicing database 740, an operations servicing computer 750, and the approved policy database 360.

The requesting member computer 710 is in communication with the member access system 320 and the elective services module 720. The member access system 320 is further in communication with the member database 230 and the elective services module 720. The elective services module 720 is further in communication with the report database 730, the policy servicing database 740, the operations servicing computer 750, and the approved policy database 360.

In operation, a requesting member (not shown) may enter an access request into the requesting member computer 710 for access to the elective services module 720. The requesting member computer 710 receives the access request and processes it to send data representing that access request to the member access system 320. The member access system 320 receives the data representing the access request from the requesting member computer 710 and searches the member database 230 for data that corresponds to the data included in the access request. If member access system 320 finds data in member database 230 that corresponds to the data included in the access request, then the member access system 320 allows the requesting member computer 710 to communicate with the elective services module 720. If member database 230 does not include data that corresponds to the data included in the access request sent from requesting member computer 710, the member access system 320 does not allow the requesting member computer 710 to access the elective services module 720. If the member access system 320 does not allow the requesting member computer 710 to communicate with the elective services module 720, the member access system 320 sends an electronic notification to the requesting member computer 710 to indicate that access to the elective services module 720 was denied, where it is displayed.

If the member access system 320 allows the requesting member computer 710 to communicate with the elective services module 720, the requesting member computer 710 may communicate with the elective services module 720. Also, the member access system 320 may send to the elective services module 720 data representing the identity of the member who wishes to access the elective services module 720. The elective services module 720 may then query the approved policy database 360 for at least some of the data representing senior life settlement policies that are associated with the requesting member who has accessed the elective services module 720 through the requesting member computer 710 and that have been approved. The elective services module 720 then communicates the retrieved data to the requesting member computer 710 where it is displayed.

In an embodiment, the requesting member computer 710 may receive as input a selection by the requesting member for policy servicing of any senior life settlement policies that the requesting member wishes to have serviced and the type of servicing the requesting member wishes to have performed. The requesting member computer 710 then processes that input to communicate data identifying the selected senior life settlement policy and the requested service to the elective services module 720. The elective services module 720 receives the data identifying the selected senior life settlement policy and the requested service from the requesting member computer 710. The elective services module 720 then communicates the data identifying the selected senior life settlement policy and the requesting service to the policy servicing database 740 where it is stored.

In another embodiment, the requesting member computer 710 may receive as input a request for third party reports for information about any other senior life settlement policies available for auction. The requesting member computer 710 then processes that input to communicate data representing the request by the requesting member for third party reports for information. The elective services module 720 receives the data representing the request by the requesting member for third party reports for information from the requesting member computer 710. The elective services module 720 then communicates the data representing the request by the requesting member for third party reports for information to the report database 730 where it is stored. The third party creates the third party report and sends it to an operations servicing user (not shown) who may upload the third party report to the operations servicing computer 750. The data representing the third party report is then communicated from the operations servicing computer 750 to the elective services module 720. The elective services module 720 receives the data representing the third party report from the operations servicing computer 750 and communicates that data to the report database 730 where it is stored.

After the elective services module 720 has received the data representing the third party report and has stored the data in the report database 730, the elective services module 720 generates an electronic notification that is communicated to the requesting member computer 710 indicating that the requested third party report is ready for review. The requesting member computer 710 then receives as input a selection by the requesting member of the third party report that the requesting member wishes to view. The requesting member computer 710 then processes that input to communicate data identifying the selected third party report to the elective services module 720. The elective services module 720 receives the data identifying the selected third party report. The elective services module 720 then retrieves data representing the selected third party report from the report database 730. The elective services module 720 then communicates the data representing the selected third party report to the requesting member computer 710 where it is displayed.

In another embodiment, the requesting member computer 710 and operations servicing computer 750 each may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, the requesting member computer 710 may be a computing device such as a personal computer, laptop computer, personal digital assistant, smart phone, tablet computer, or other computing device.

In another embodiment, the operations servicing computer 750 may be a computing device such as a personal computer, laptop computer, personal digital assistant, smart phone, tablet computer, or other computing device.

In another embodiment, the member database 230 may be an electronic database.

In another embodiment, the report database 730 may be an electronic database.

In another embodiment, the policy servicing database 740 may be an electronic database.

In another embodiment, the approved policy database 360 may be an electronic database.

In another embodiment, the communication between the requesting member computer 710 and the member access system 320 may be through a network connection, Ethernet connection, internet connection, file transfer protocol connection, RF connection, infrared connection, wireless connection, photonic connection, or other electronic connection.

In another embodiment, the communication between the member access system 320 and the member database 230 may be through a network connection, Ethernet connection, internet connection, SQL connection, RF connection, infrared connection, wireless connection, photonic connection, or other electronic connection.

In another embodiment, the communication between the member access system 320 and the elective services module 720 may be through a network connection, Ethernet connection, internet connection, file transfer protocol connection, RF connection, infrared connection, wireless connection, photonic connection, or other electronic connection.

In another embodiment, the communication between the requesting member computer 710 and the elective services module 720 may be through a network connection, Ethernet connection, internet connection, file transfer protocol connection, RF connection, infrared connection, wireless connection, photonic connection, or other electronic connection.

In another embodiment, the communication between the elective services module 720 and the report database 730 may be through a network connection, Ethernet connection, internet connection, SQL connection, RF connection, infrared connection, wireless connection, photonic connection, or other electronic connection.

In another embodiment, the communication between the elective services module 720 and the approved policy database 360 may be through a network connection, Ethernet connection, internet connection, SQL connection, RF connection, infrared connection, wireless connection, photonic connection, or other electronic connection.

In another embodiment, the communication between the elective services module 720 and the policy servicing database 740 may be through a network connection, Ethernet connection, internet connection, SQL connection, RF connection, infrared connection, wireless connection, photonic connection, or other electronic connection.

In another embodiment, the communication between the elective services module 720 and the operations servicing computer 750 may be through a network connection, Ethernet connection, internet connection, RF connection, infrared connection, wireless connection, photonic connection, or other electronic connection.

In another embodiment, the elective services module 720 may be a software program containing a set of instructions stored in at least one computer-readable medium that are executable to cause a system to perform operations based on the instructions.

In another embodiment, the elective services module 720 may be stored on a server, a plurality of servers, a mobile server, a desktop computer, a workstation, a laptop computer, in a cloud computing network, or other similar computing device.

In another embodiment, the member access system 320 may be a software program containing a set of instructions stored in at least one computer-readable medium that are executable to cause a system to perform operations based on the instructions.

In another embodiment, the member access system 320 may be stored on a server, a plurality of servers, a mobile server, a desktop computer, a workstation, a laptop computer, in a cloud computing network, or other similar computing device.

In another embodiment, the data representing the access request sent from the requesting member computer 710 may include a username and password.

In another embodiment, the data representing the access request sent from the requesting member computer 710 may include a username and PIN code.

In another embodiment, the third party reports that may be requested through the elective services module 720 may include life expectancy reports, medical reports, mortality reports, a background check, a report including the net worth of an underlying insured individual, premium source check, verification of coverage.

In another embodiment, the access request entered by the listing user into a web-based interface supported by the member access system 320 displayed on the requesting member computer 710.

In another embodiment, if access to the elective services module 720 is denied, the electronic notification sent to the requesting member computer 710 that indicates that access to the elective services module 720 was denied may be displayed in a web-based interface supported by the member access system 320 displayed on the requesting member computer 710.

In another embodiment, the data representing senior life settlement policies that are associated with the requesting member who has accessed the elective services module 720 may be displayed in a web-based interface supported by the elective services module 720 displayed on the requesting member computer 710.

In another embodiment, the selection by the requesting member of any senior life settlement policies that the requesting member wishes to have serviced may be entered into a web-based interface supported by the elective services module 720 displayed on the requesting member computer 710.

In another embodiment, the selection by the requesting member of any senior life settlement policies that the requesting member wishes to have serviced may be made by clicking a hyperlink representing the senior life settlement policy in a web-based interface supported by the elective services module 720 displayed on requesting member computer 710.

In another embodiment, the selection by the requesting member of any senior life settlement policies that the requesting member wishes to have serviced may be made by selecting a radio button next to the policy or policies in a web-based interface supported by the elective services module 720 displayed on the requesting member computer 710.

In another embodiment, the selection by the requesting member of any senior life settlement policies that the requesting member wishes to have serviced may be made by selecting a check box next to the policy or policies in a web-based interface supported by the elective services module 720 displayed on the requesting member computer 710.

In another embodiment, the selection by the requesting member of any senior life settlement policies that the requesting member wishes to have serviced may be made by selecting the policies or policies from a pre-populated drop down list of policies in a web-based interface supported by the elective services module 720 displayed on the requesting member computer 710.

In another embodiment, servicing of policies requested by the requesting member may include payment of premiums for an underlying life insurance policy.

In another embodiment, after the elective services module 720 has communicated the data representing the request by the requesting member for third party reports for information to the report database 730 where it is stored, and after the third party has created the requested third party report, the third party may send the report directly to the requesting member physically or electronically.

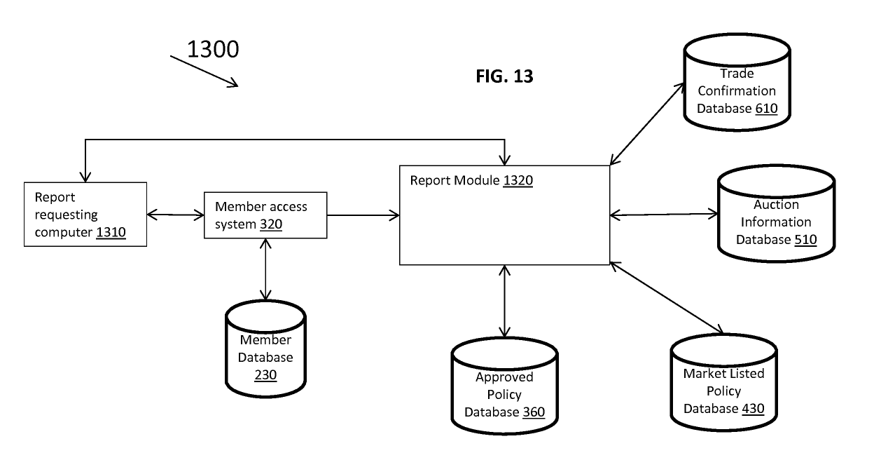

FIG. 13 is a block diagram illustrating an embodiment of a reporting system 1300, which may be a part of the exchange system 100. The reporting system 1300 may include a report requesting computer 1310, the member access system 320, the member database 230, a report module 1320, the approved policy database 360, the market listed policy database 430, the auction information database 510, and the trade confirmation database 610.

The report requesting computer 1310 is in communication with the member access system 320 and the report module 1320. The member access system 320 is further in communication with the member database 230 and the report module 1320. The report module 1320 is further in communication with the approved policy database 360, the market listed policy database 430, the auction information database 510, and the trade confirmation database 610.

In operation, a member requesting a report (not shown) may enter an access request into report requesting computer 1310 through which the member may request a report for access to the report module 1320. Report requesting computer 1310 receives the access request and processes it to send data representing that access request to the member access system 320. The member access system 320 receives the data representing the access request from report requesting computer 1310 and searches the member database 230 for data that corresponds to the data included in the access request. If member access system 320 finds data in member database 230 that corresponds to the data included in the access request, then the member access system 320 allows report requesting computer 1310 to communicate with the report module 1320. If member database 230 does not include data that corresponds to the data included in the access request sent from report requesting computer 1310, the member access system 320 does not allow report requesting computer 1310 to access the report module 1320. If the member access system 320 does not allow report requesting computer 1310 to communicate with the report module 1320, the member access system 320 sends an electronic notification to report requesting computer 1310 to indicate that access to the report module 1320 was denied, where it is displayed.

If the member access system 320 allows report requesting computer 1310 to communicate with the report module 1320, report requesting computer 1310 may communicate with the report module 1320.

Report requesting computer 1310 may receive as input a request a member to view a report of data stored in any of the approved policy database 360, the market listed policy database 430, the auction information database 510, the trade confirmation database 610, or any combination thereof. Report requesting computer 1310 then processes that input to communicate data representing the request by the member and sends that data to the report module 1320. The report module 1320 receives the data representing the request by the member to view a report from report requesting computer 1310. The report module 1320 then processes the data representing the request by the member to view a report to determine which databases need to be queried to create the requested report. The report module 1320 may need to query for data stored in the approved policy database 360, the market listed policy database 430, the auction information database 510, or the trade confirmation database 610, or any combination of these databases, depending on the request from the member.

After the report module 1320 has determined which databases to query, the report module 1320 retrieves the necessary data from the appropriate databases and compiles the data into a report. The report module then communicates the report to the report requesting computer 1310 where it is displayed.

In another embodiment, report requesting computer 1310 may be a hand-held device, laptop, portable computer, personal computer, desktop computer, or a larger computer such as a workstation or multiprocessor. Generally, each computer includes a monitor (or any other output device) and an input device, such as a keyboard, pen pad, touch screen, and/or a mouse to support click based data entry, if so desired. One skilled in the art of the present invention will understand that the example embodiments are not limited to any particular class or model of computer employed for these computers and will be able to select an appropriate system. It should be noted that each computer employed here generally includes a central processing unit, a memory (a primary and/or secondary memory unit), an input interface for receiving data from a communications network, an input interface for receiving in put signals from one or more input devices (for example, a keyboard, mouse, etc.) and an output interface for communications with an output device (for example, a monitor). A system bus or equivalent system may provide communications between these various elements.

In another embodiment, report requesting computer 1310 may be a computing device such as a personal computer, laptop computer, personal digital assistant, smart phone, tablet computer, or other computing device.

In another embodiment, the member database 230 may be an electronic database.

In another embodiment, the approved policy database 360 may be an electronic database.

In another embodiment, the market listed policy database 430 may be an electronic database.

In another embodiment, the auction information database 510 may be an electronic database.

In another embodiment, the trade confirmation database 610 may be an electronic database.

In another embodiment, the communication between report requesting computer 1310 and the member access system 320 may be through a network connection, Ethernet connection, internet connection, file transfer protocol connection, RF connection, infrared connection, wireless connection, photonic connection, or other electronic connection.

In another embodiment, the communication between report requesting computer 1310 and report module 1320 may be through a network connection, Ethernet connection, internet connection, file transfer protocol connection, RF connection, infrared connection, wireless connection, photonic connection, or other electronic connection.

In another embodiment, the communication between the member access system 320 and the member database 230 may be through a network connection, Ethernet connection, internet connection, SQL connection, RF connection, infrared connection, wireless connection, photonic connection, or other electronic connection.

In another embodiment, the communication between the report module 1320 and the member access system 320 may be through a network connection, Ethernet connection, internet connection, file transfer protocol connection, RF connection, infrared connection, wireless connection, photonic connection, or other electronic connection.

In another embodiment, the communication between the report module 1320 and the approved policy database 360 may be through a network connection, Ethernet connection, internet connection, SQL connection, RF connection, infrared connection, wireless connection, photonic connection, or other electronic connection.

In another embodiment, the communication between the report module 1320 and the market listed policy database 430 may be through a network connection, Ethernet connection, internet connection, SQL connection, RF connection, infrared connection, wireless connection, photonic connection, or other electronic connection.

In another embodiment, the communication between the report module 1320 and the auction information database 510 may be through a network connection, Ethernet connection, internet connection, SQL connection, RF connection, infrared connection, wireless connection, photonic connection, or other electronic connection.

In another embodiment, the communication between the report module 1320 and the trade confirmation database 610 may be through a network connection, Ethernet connection, internet connection, SQL connection, RF connection, infrared connection, wireless connection, photonic connection, or other electronic connection.

In another embodiment, the report module 1320 may be a software program containing a set of instructions stored in at least one computer-readable medium that are executable to cause a system to perform operations based on the instructions.

In another embodiment, the report module 1320 may be stored on a server, a plurality of servers, a mobile server, a desktop computer, a workstation, a laptop computer, in a cloud computing network, or other similar computing device.

In another embodiment, the member access system 320 may be a software program containing a set of instructions stored in at least one computer-readable medium that are executable to cause a system to perform operations based on the instructions.

In another embodiment, the member access system 320 may be stored on a server, a plurality of servers, a mobile server, a desktop computer, a workstation, a laptop computer, in a cloud computing network, or other similar computing device.

In another embodiment, the data representing the access request sent from report requesting computer 1310 may include a username and password.

In another embodiment, the data representing the access request sent from report requesting computer 1310 may include a username and PIN code.

In another embodiment, and by way of example only and not intending to limit the possibilities in any way, a report requested by a report requesting member may display the number of transactions that occurred in the exchange system 100 during a certain time period, the average price of transactions that occurred in the exchange system 100 during a certain time period, the status of any senior life settlement policy listed for auction in the exchange system 100, or other similar reports.

In another embodiment, the access request entered by the listing user into a web-based interface supported by the member access system 320 displayed on computer 1310.

In another embodiment, if access to the report module 1320 is denied, the electronic notification sent to the report requesting member computer 1310 that indicates that access to the report module 1320 was denied may be displayed in a web-based interface supported by the member access system 320 displayed on the report requesting member computer 1310.

In another embodiment, the request to view reports input by the report requesting member may be entered into a web-based interface supported by the report module 1320 displayed on the report requesting member computer 1310.

In another embodiment, the report communicated to the report requesting computer 1310 from the report module 1320 may be viewable in PDF format.

In another embodiment, the report communicated to the report requesting computer 1310 from the report module 1320 may be viewable through a web-based interface supported by the report module 1320 displayed on the report requesting computer 1310.

In another embodiment, the report communicated to the report requesting computer 1310 from the report module 1320 may be viewable in spreadsheet format.

In an embodiment, the member creation module 220, member access system 320, policy approval module 350, securities intermediary system 370, policy listing module 420, auction module 520, trade confirmation module 620, elective services module 720, and report module 1320 are each software configured to extract information (for example, the reserve price) from data representing the information (for example, data representing the reserve price) when data representing the information is retrieved from a database (for example, from the auction information database 510 which stores data representing the reserve price).

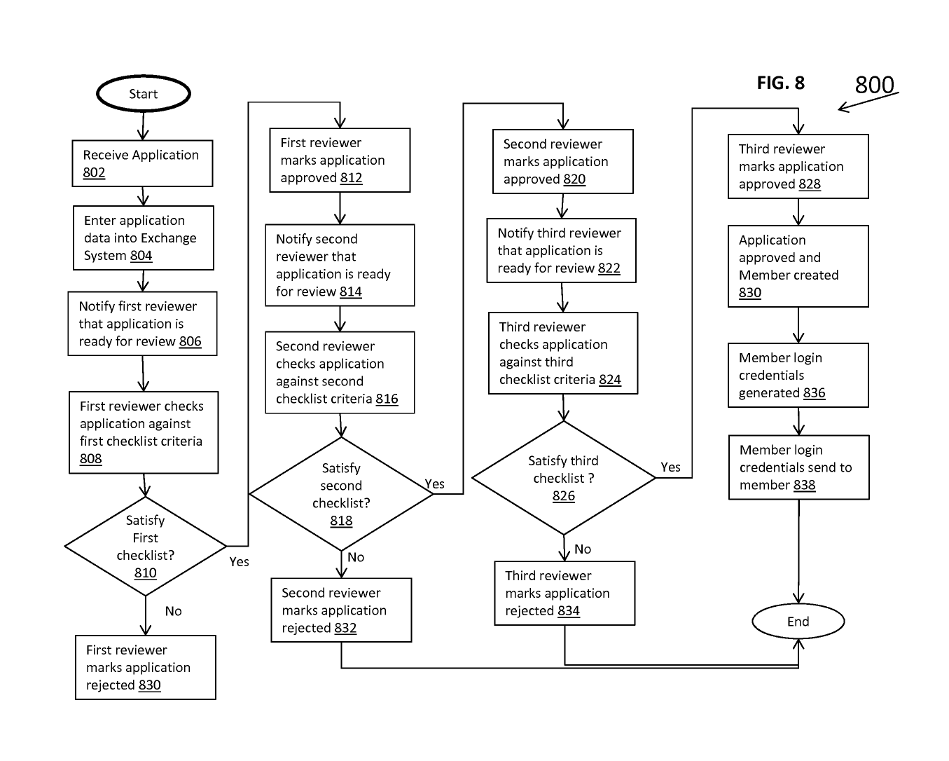

FIG. 8 is a flow chart 800 illustrating one example method for approving members of the exchange system, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 802, an application for membership is received. In an embodiment, the application may be received physically in hard copy form. In another embodiment, the application may be received via electronic communication, such as electronic mail. In another embodiment, it may be received through a web-based interface displayed on a computer.

At step 804, data representing the application is entered into the exchange system. In an embodiment, a user may enter this data using a computer, generally as described above. In another embodiment, the application may be scanned and stored in the exchange system. In another embodiment, data may be input into the exchange system by an exchange system user through a web-based interface displayed on a computer.

At step 806, a first reviewer is notified that an application is ready for review. In an embodiment, the first reviewer may receive an electronic notification that is displayed through a web-based interface on a computer, generally as described above.

At step 808, the first reviewer compares the application against a first checklist of criteria to determine if the application should be approved or rejected. In an embodiment, the first reviewer may view the application through a web-based interface on a computer, generally as described above. In an embodiment, the first checklist of criteria may include a check that the application has been completed. In another embodiment, the first checklist of criteria may include a check to determine if the applicant is a Qualified Institutional Buyer (“QIB”) as defined by the United States Securities Laws.

At step 810, based on the first reviewer's comparison of the application to the first checklist of criteria, the first reviewer determines if the application meets the first checklist of criteria or not.

If the application meets the first checklist of criteria, the first reviewer marks the application approved at step 812. In an embodiment, the first reviewer marks the application as approved through a web-based interface displayed on a computer, generally as described above. If the application does not meet the first checklist of criteria, the first reviewer marks the application rejected at 830. In an embodiment, the first reviewer marks the application as rejected through a web-based interface displayed on a computer, generally as described above. In an embodiment, a web-based interface displayed on a computer may accept entry of text indicating whether the application was approved or rejected by the first reviewer. In another embodiment, a web-based interface displayed on a computer may accept a selection from a drop-down list that includes predetermined values indicating whether the application was approved or rejected by the first reviewer. In another embodiment, a web-based interface displayed on a computer may accept selection of a radio button next to values indicating whether the application was approved or rejected by the first reviewer.

If the first reviewer marked the application approved at step 812, then the second reviewer is notified that the application is ready for review at step 814. In an embodiment, the second reviewer may receive an electronic notification through a computer, generally as described above. In an embodiment, the electronic notification may be displayed through a web-based interface on a computer used by the second reviewer, generally as described above.

At step 816, the second reviewer compares the application against a second checklist of criteria to determine if the application should be approved or rejected. In an embodiment, the second checklist of criteria may include a check to determine if the applicant is a Qualified Institutional Buyer (“QIB”) as defined by the United States Securities Laws.

At step 818, based on the second reviewer's comparison of the application to the second checklist of criteria, the second reviewer determines if the application meets the second checklist of criteria or not. If the application meets the second checklist of criteria, the second reviewer marks the application approved at step 820. In an embodiment, the second reviewer marks the application as approved through a computer, generally as described above. If the application does not meet the second checklist of criteria, the second reviewer marks the application rejected at step 832. In an embodiment, the second reviewer marks the application as rejected through a computer, generally as described above, In an embodiment, a web-based interface displayed on the second reviewer's computer may accept entry of text indicating whether the application was approved or rejected by the second reviewer. In another embodiment, the web-based interface may accept a selection from a drop-down list that includes predetermined values indicating whether the application was approved or rejected by second reviewer. In another embodiment, the web-based interface may accept selection of a radio button next to values indicating whether the application was approved or rejected by the second reviewer.

If the second reviewer marked the application approved at step 820, then the third reviewer is notified that a member application is ready for review at step 822. In an embodiment, the third reviewer may receive an electronic notification through a computer, generally as described above. In an embodiment, the electronic notification may be displayed through a web-based interface on a computer used by the third reviewer, generally as described above.

At step 824, the third reviewer compares the application against a third checklist of criteria to determine if the application should be approved or rejected. In an embodiment, the third checklist of criteria may include a check to determine if the applicant is a Qualified Institutional Buyer (“QIB”) as defined by the United States Securities Laws.

At step 826, based on the third reviewer's comparison of the application to the third checklist of criteria, the third reviewer determines if the application meets the third checklist of criteria or not. If the application meets the third checklist of criteria, the third reviewer marks the application approved at step 828. In an embodiment, the third reviewer marks the application as approved through a computer, generally as described above. If the application does not meet the third checklist of criteria, the third reviewer marks the application rejected at step 834. In an embodiment, the third reviewer marks the application as rejected through a computer, generally as described above. In an embodiment, a web-based interface displayed on the third reviewer's computer may accept entry of text indicating whether the application was approved or rejected by the third reviewer. In another embodiment, the web-based interface may accept a selection from a drop-down list that includes predetermined values indicating whether the application was approved or rejected by third reviewer. In another embodiment, the web-based interface may accept selection of a radio button next to values indicating whether the application was approved or rejected by the third reviewer.

If the third reviewer marked the application approved at step 828, then the application may be considered approved and the member is created at step 830. Then, the member's login credentials are generated at step 836 and communicated to the member at step 838. In an embodiment, the member's login credentials may be generated by a computer and may be communicated to the member electronically, such as through electronic mail, for example.

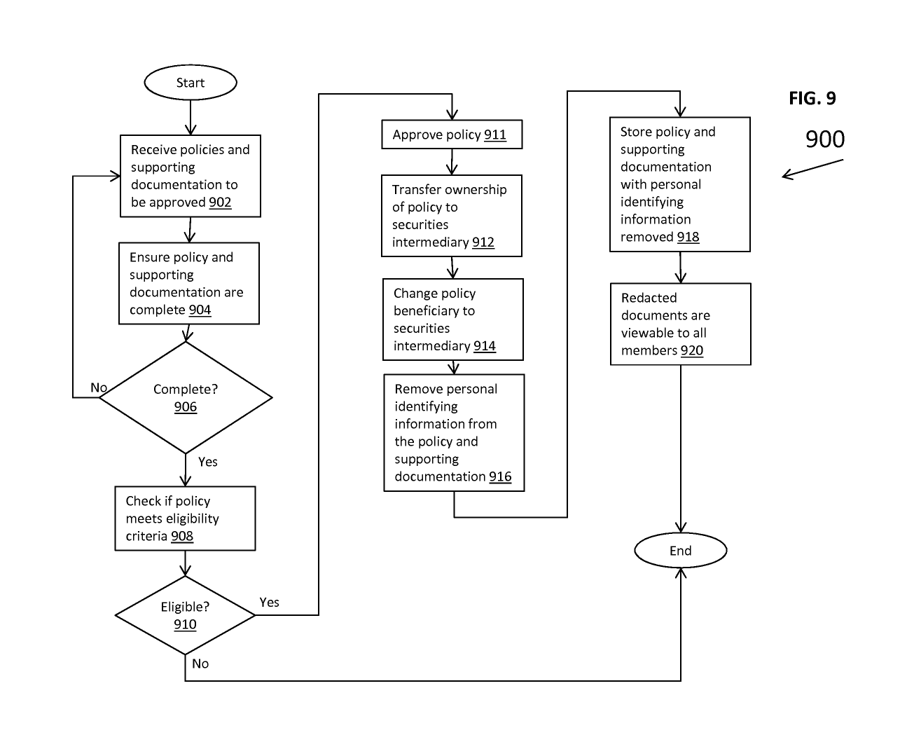

FIG. 9 is a flow chart 900 illustrating an example method for approving and dematerializing senior life settlement policies prior to auction, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 902, the senior life settlement policy and supporting documentation are received. In an embodiment, the senior life settlement policy and supporting documentation may be received physically in hard copy form. In another embodiment, the senior life settlement policy and supporting documentation may be received via electronic communication, such as electronic mail.

At step 904, the senior life settlement policy and supporting documentation may be reviewed to ensure that the senior life settlement policy and supporting documentation are complete. If it is determined that they are not complete at step 906, any missing documentation may be requested from the member seeking to list the senior life settlement policy for auction, and at step 902 the missing documentation may be received from the member seeking to list the senior life settlement policy for auction. The process including steps 902-904-906 may be repeated until the senior life settlement policy and supporting documentation are complete.

If it is determined that the senior life settlement policy and supporting documentation are complete at step 906, then at step 908 the senior life settlement policy is checked to determine if the senior life settlement policy meets exchange eligibility criteria. To make this determination, a reviewer may check the senior life settlement policy against a checklist of criteria.

If it is determined that the senior life settlement policy is eligible to be listed on the exchange system, then the policy is marked as approved at step 911. In an embodiment, a user marks the policy as approved through a computer, generally as described above. In another embodiment, the policy is marked as approved through a web-based interfaced displayed on a computer.

After a policy has been marked as approved at step 911, the member seeking to list the senior life settlement policy on the exchange executes an ownership change form at step 912 designating the securities intermediary as the owner of the policy and a beneficiary change form at step 914 designating the securities intermediary as the beneficiary of the policy, generally as described above. In an embodiment, the ownership change form and beneficiary change form are sent electronically to the member. In another embodiment, the ownership change form and beneficiary change form are completed by a securities intermediary and then sent electronically to the member.

After the ownership change form and beneficiary change form have been executed by the member and the securities intermediary, at step 916 the personal identifying information relating to the insured individual of the underlying policy must be removed from the policy documentation and all supporting documentation. In an embodiment, this information may be removed from the policy and all supporting documentation using a computer. In another embodiment, this information may be redacted from the policy and all supporting documentation using a computer.

At step 918, the policy and all supporting documentation with personal identifying information removed or redacted is stored for the auction. In an embodiment, the policy and all supporting documentation with personal identifying information removed or redacted may be stored electronically in a database.

After the personal identifying information has been removed or redacted from the policy and all supporting documentation, the policy and all supporting documentation with personal identifying information removed or redacted may be made available to all members of the exchange system at step 920. A member of the exchange may wish to view these documents to determine if they want to bid on the senior life settlement policy. In an embodiment, members may view the senior life settlement policy and all supporting documentation with personal identifying information removed through a web-based interface on a computer.

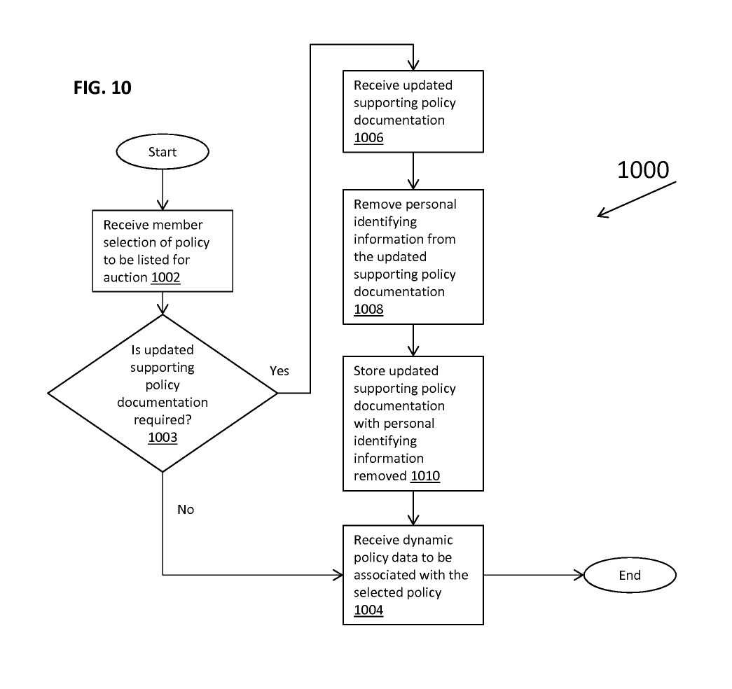

FIG. 10 is a flow chart 1000 illustrating one example method for listing on the exchange for auction, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 1002, a member who wishes to make a senior life settlement policy available for auction selects a policy owned by the member that the member wishes to make available for auction. In an embodiment, the member may select a policy that the member wishes to make available for auction through a computer, generally as described above. In another embodiment, the member selects the policy they wish to make available for auction through a web-based interface displayed on a computer, generally as described above.

At step 1003, the member must determine if updated supporting policy documentation is required. The member makes this determination by comparing the supporting policy documentation submitted with the original policy application to any new supporting policy documentation that the member has received. If the member has updated supporting policy documentation, then the member may submit the updated supporting policy documentation.

At step 1004, after the member has determined that there is no updated supporting policy documentation to be uploaded, the member enters dynamic policy data that is used to govern the auction of the selected senior life settlement policy, generally as described above. In an embodiment, dynamic policy data may include auction duration, auction start date, auction end date, reserve price, an indicator of whether to extend the auction by a predetermined amount of time if bids are not high enough, account value, surrender value, account value date, surrender value date, the following month's deductions for the cost of insurance, the name of the qualified securities intermediary, and an indicator representing whether the selling member has paid all premiums on the policy to keep it in force and out of grace period for the next 30 days, date of last premium payment, amount of last premium payment, and the date through which the premiums have been paid. In an embodiment, the member may enter the dynamic policy data through a web-based interface on a computer, generally as described above. The dynamic policy data entered by the member may then be associated with the selected senior life settlement policy. In an embodiment, dynamic policy data is entered through a computer, generally as described above. In another embodiment, dynamic policy data is entered through a web-based interface displayed on a computer, generally as described above.

At step 1006, after the member has determined that updated supporting policy documentation needs to be uploaded, the member uploads the updated supporting documentation generally as described above. Then, the member transmits the updated supporting policy documentation which is received by the exchange system. In an embodiment, the member scans the updated supporting policy documentation into a computer and then communicates the scanned updated supporting policy documentation using a web-based interface on a computer. In another embodiment, the member transmits data representing the updated supporting policy documentation using a computer.

At step 1008, any personal identifying information is redacted from the updated supporting policy documentation. In an embodiment, this information may be removed from the data representing the policy and all supporting documentation using a computer. In another embodiment, this information may be redacted from the data representing the policy and all supporting documentation using a computer.

At step 1010, the data representing the updated supporting policy documentation with personal identifying information redacted is stored. In an embodiment, this data is stored electronically in a database.

After the data representing the updated supporting policy documentation with personal identifying information redacted is stored at step 1010, the member is notified that dynamic policy data may be entered for the selected senior life settlement policy the member wishes to make available for auction, generally as described above. In an embodiment, an electronic notification is generated and communicated to the member's computer.

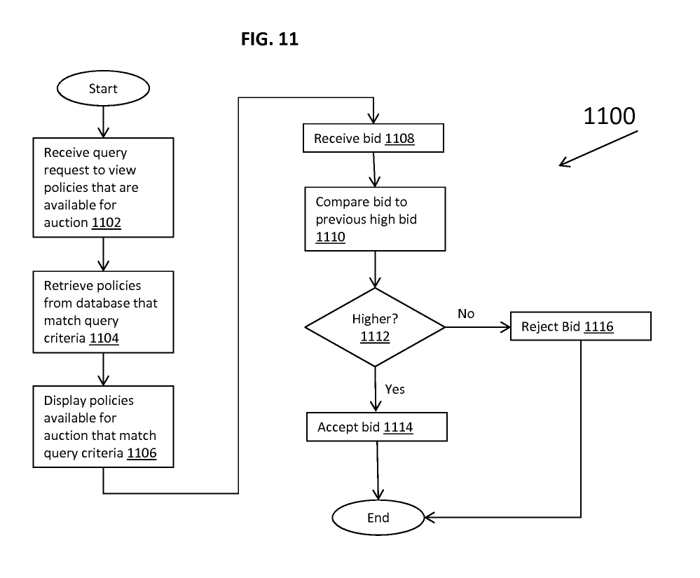

FIG. 11 is a flow chart 1100 illustrating one example method for conducting the auction, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 1102, a query request to view policies that meet the query criteria that are available for auction is received. In an embodiment, the query request may be submitted by a member through a web-based interface displayed on a computer, generally as described above.

At step 1104, the policies that match the query criteria are retrieved, generally as described above. In an embodiment, the policies that match the query criteria may be retrieved from an electronic database.

At step 1106, the policies that match the query criteria are displayed for review by the member. In an embodiment, the policies that match the query criteria may be displayed through a web-based interface on a computer, generally as described above. The member can decide which, if any, policies for which the member wishes to enter a bid. In an embodiment, the member may select which policies for which the member wishes to enter a bid through a computer, generally as described above. In an embodiment, the member may select a policy on which to enter a bid by clicking on a check box next to the policy through a web-based interface displayed on a computer. In an embodiment, the member may select a policy on which to enter a bid by clicking on a radio button next to the policy through a web-based interface displayed on a computer. In an embodiment, the member may select a policy on which to enter a bid by selecting a policy from a drop-down list that has been pre-populated through a web-based interface displayed on a computer. In an embodiment, the member may select a policy on which to enter a bid by clicking on a hyperlink identifying the policy through a web-based interface displayed on a computer.

At step 1108, the member then enters a bid amount for a particular policy or block of policies offered for auction together. In an embodiment, the member may enter the bid amount as text through a web-based interface on a computer, generally as described above. In another embodiment, the member may enter the bid amount by selecting an amount from a drop-down list that has been pre-populated through a web-based interface displayed on a computer. In an embodiment, the bid may be communicated from a computer into which the member entered the bid to the exchange system. After the bid is received, the bid is compared to the previous high bid, because the bid must be higher than the previous high bid to be accepted. In an embodiment, the previous high bid for a particular senior life settlement policy may be retrieved from an electronic database. In another embodiment, before a bid is entered at step 1108, a member may wish to view the senior life settlement policy or any supporting documentation with personal identifying information removed. In that case, the member may enter a request to view the senior life settlement policy or any supporting documentation with personal identifying information removed generally as described above.

At step 1110, the bid is compared to the previous high bid for the particular policy or block of policies. In an embodiment, the comparison of the previous high bid to the current bid may be performed by software, generally as described above.

At step 1112, if the member's bid is equal to or lower than the previous high bid for the particular policy or block of policies, the bid is rejected at step 1116. In an embodiment, an electronic notification may be sent to the computer through which the member entered the bid to notify the member that the bid was not accepted, generally as described above. However, if the member's bid is higher than the previous high bid, then the bid is accepted at step 1114 and becomes the new high bid for the particular policy. In an embodiment, an electronic notification may be sent to the computer through which the member entered the bid to notify the member that the bid was accepted. If the bid was accepted, an electronic database storing the bid history is then updated to reflect the new high bid.

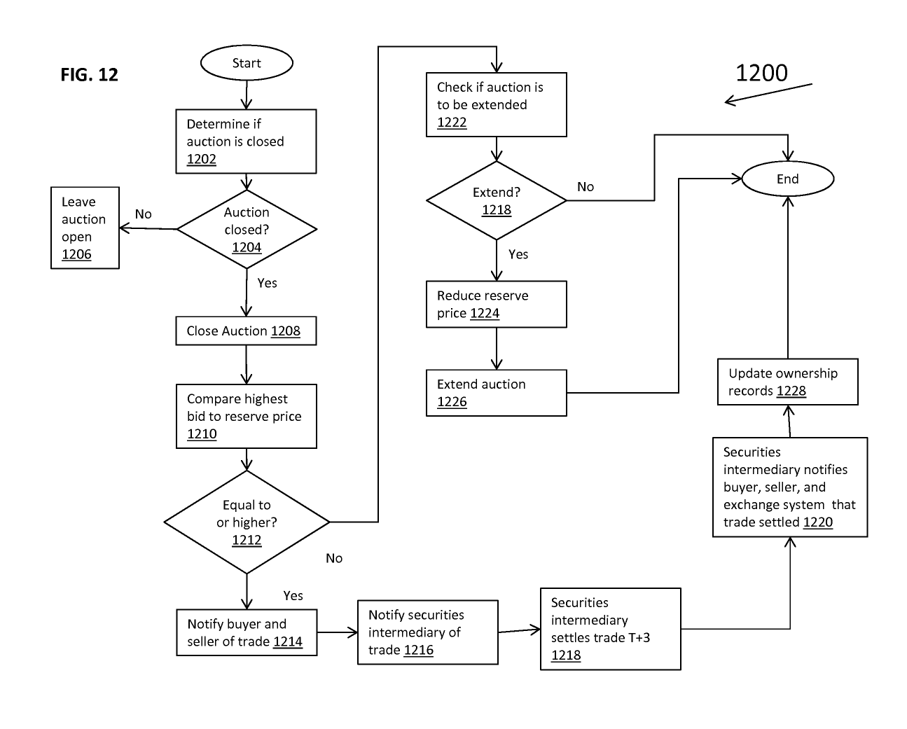

FIG. 12 is a flow chart 1200 illustrating one example method for confirming a trade, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 1202, it must be determined whether the auction for a particular senior life settlement policy is closed. In an embodiment, the exchange system may determine that the auction is closed by retrieving the auction end date associated with a particular policy from a database and comparing that date to the current date. If the exchange system determines that the current date is equal to or later than the auction end date, the exchange system determines that the auction end date has passed and the auction is closed. If the exchange system determines that the current date is earlier than the auction end date, the exchange system determines that the auction is to be left open.

At step 1204, if it is determined that the auction is to be left open, the auction is left open at step 1206 and further bids are accepted. If it is determined that the auction end date has passed and the auction is closed, the auction is closed at step 1208 and no further bids are accepted for a particular policy. In an embodiment, if the exchange system determines that the auction is to be closed, then the exchange system closes the auction at step 1208, at which point the exchange system does not accept any more bids on the particular policy.

At step 1210, the highest bid is compared to the reserve price. In an embodiment, the exchange system retrieves the highest bid associated with the particular policy and the reserve price associated with the particular policy from a database and then compares those values.

At step 1212, if the highest bid is equal to or higher than the reserve price for the particular policy, the buyer and seller are notified that the particular policy was traded at step 1214. In an embodiment, the exchange system may send an electronic notification to the buyer's computer and to the seller's computer. In an embodiment, the electronic notification sent to the buyer's computer may be displayed through a web-based interface on the buyer's computer and the electronic notification sent to the seller's computer may be displayed through a web-based interface on the seller's computer.

At step 1216, the securities intermediary is notified that the policy was traded. In an embodiment, the exchange system may send an electronic notification to a securities intermediary system that the policy was traded along with data representing information about the trade including, for example, the date of auction, the buyer member, the seller member, and the auction amount, generally as described above. The securities intermediary system may then store that data in a database.

At step 1218, the securities intermediary settles the transaction within three business days of the auction date (“T+3”).

At step 1220, after the securities intermediary has settled the transaction within three business days (T+3), the securities intermediary notifies the buyer, seller, and exchange system that the trade has been settled. In an embodiment, the securities intermediary sends an electronic notification to the buyer's computer, to the seller's computer, and to the exchange system that includes data indicating that the trade has been settled and data representing the date of settlement, generally as described above. In an embodiment, the electronic notification sent to the buyer's computer may be displayed through a web-based interface on the buyer's computer and the electronic notification sent to the seller's computer may be displayed through a web-based interface on the seller's computer. The exchange system receives the data in the electronic notification and stores it in a database. In another embodiment, the securities intermediary sends an electronic notification to the exchange system, which then sends an electronic notification to the buyer's computer and the seller's computer. In an embodiment, the electronic notification sent to the buyer's computer from the exchange system may be displayed through a web-based interface on the buyer's computer and the electronic notification sent from the exchange system to the seller's computer may be displayed through a web-based interface on the seller's computer. The exchange system receives the data in the electronic notification and stores it in a database.

At step 1222, if the highest bid is less than the reserve price for the particular policy, it must be determined if the auction is to be extended. In an embodiment, the exchange system may check to see if the auction is to be extended by retrieving from a database data indicating whether the auction should be extended.

At step 1218, a determination is made whether the auction is to be extended. In an embodiment, the exchange system may determine that the auction is to be extended based on the indicator retrieved from a database that the auction is to be extended. If the auction is not to be extended, then the auction is over and no trade occurs. In an embodiment, the exchange system may determine that the auction is not to be extended based on the indicator retrieved from a database that the auction is to be extended.

If the auction is to be extended, then the reserve price for the particular policy is reduced at step 1224. In an embodiment, the exchange system may retrieve from a database the amount by which the reserve price is to be reduced, process that data to reduce the reserve price and store the new reduced reserve price in a database.

At step 1226, after the reserve price has been reduced, the auction period is extended. In an embodiment, the exchange system may extend the auction period by retrieving from a database a value indicating by how much to extend the auction period for the particular policy, process that data to generate a new auction end date, and then store the new auction end date in a database. In another embodiment, the exchange system may extend the auction period by a predetermined value, process the data to generate a new auction end date, and then store the new auction end date in a database.

At step 1228, after a trade has occurred, the ownership records for the senior life settlement policy that was auctioned must be updated. In an embodiment, a securities intermediary system receives as input data representing the new owner of the senior life settlement policy. The securities intermediary then stores that data in a securities intermediary database. The securities intermediary system then sends an electronic communication to the exchange system with data indicating the new ownership for the senior life settlement policy. The exchange system receives the data and stores it in a database.

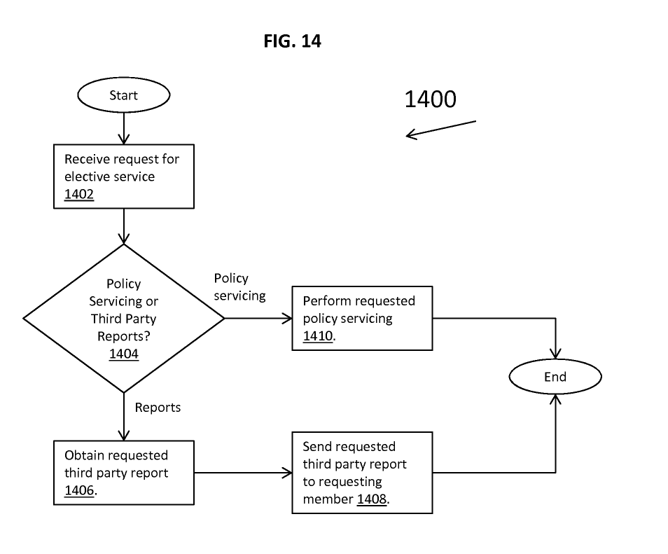

FIG. 14 is a flowchart 1400 illustrating one example method for performing elective services, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 1402, a request for elective services is received. In an embodiment, the request for elective services may be submitted by a member through a web-based interface displayed on a computer, generally as described above.

At step 1404, it must be determined whether the request is for policy servicing or for a third party report. In an embodiment, the determination of whether the request is for policy servicing or for a third party report is performed by software, generally as described above. In another embodiment, the member making the request specifies whether the member wants policy servicing or a third party report through a web-based interface displayed on a computer, generally as described above.

At step 1406, after it has been determined that the member wishes to obtain a third party report, an exchange system operations user obtains the requested third party report. In an embodiment, the third party report must be obtained from a third party, generally as described above. In another embodiment, the third party report may be life expectancy reports, medical reports, mortality reports, a background check, a report including the net worth of an underlying insured individual, premium source check, verification of coverage, and updated senior life settlement documentation, or other report.

At step 1408, after the requested third party report has been obtained, the third party report is sent to the requesting member. In an embodiment, the third party report is sent electronically to the requesting member's computer, generally as described above.

At step 1410, after it has been determined that the member wishes to have policy servicing performed, an exchange operations user performs the requested policy servicing. In an embodiment, the requested policy servicing may include paying the future premiums for an underlying life insurance policy on time to ensure that the life insurance policy remains in force.

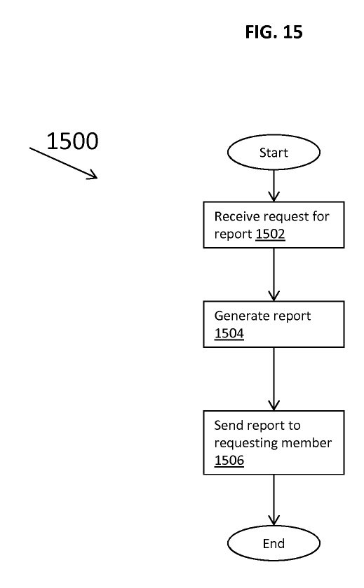

FIG. 15 is a flow chart 1500 illustrating one example method for providing reports, according to an embodiment of the present invention. Also, it should be understood that the flow chart only shows the functionality and operation of a possible implementation of the present embodiments. In this regard, each block may represent a module, a segment, or a portion of code, which includes one or more executable instructions for implementing specific logical functions or steps in the process. Alternative implementations are included within the scope of example embodiments of the present invention in which functions maybe executed out of order from that shown or discussed, including substantially concurrent or in reverse order, depending on the functionality involved, as would be understood by those reasonably skilled in the art of the present invention. The flowchart is shown to have various steps. Some steps may be omitted, and/or may be performed in a different order. The method may be performed using systems substantially as described above.

At step 1502, a request for a report is received, In an embodiment, the request for a report may be submitted by a member through a web-based interface displayed on a computer, generally as described above. In another embodiment, the request may be for a report on the number of transactions that have occurred during a certain time period, or for a report on the average price of transactions that have occurred during a certain time period, or for the status of a particular senior life settlement policy, or for other information that the member wishes to see.

At step 1504, the requested report is generated. In an embodiment, the requested report is generated by software, generally as described above. In another embodiment, a database is queried by software to retrieve the data necessary to generate the report. In another embodiment, a plurality of databases are queried by software to retrieve the data necessary to generate the report.

At step 1506, after the report has been generated, the report is sent to the member who requested the report. In an embodiment, the report is sent electronically to the member's computer, generally as described above. In another embodiment, the report is displayed on the member's computer, generally as described above. In another embodiment, the report is displayed in PDF format, generally as described above. In another embodiment, the report is displayed in web-based interface, generally as described above.

The invention described herein provides an efficient market for buying and selling senior life settlement policies. It allows only approved members to participate. It permits only approved senior life settlement policies to be listed for auction. It provides for dematerializing senior life settlement policies so that auction transactions can be settled efficiently, within three business days. It provides that ownership of a senior life settlement policy listed for auction is assigned to a securities intermediary who is responsible for settling the auction transactions.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What is claimed is:

1. A computer-implemented method for conducting an auction of a senior life settlement policy, said method comprising:
providing an exchange computer configured to:
receive, from a securities intermediary computer, data representing that title to a senior life settlement policy is held by a third party securities intermediary;
receive, from a seller computer, dynamic policy data associated with the senior life settlement policy;
store, in a market listed policy database, the dynamic policy data associated with the senior life settlement policy;
determine that the senior life settlement policy is available for auction;
receive, from a buyer computer, a bid to purchase the senior life settlement policy;
retrieve, from an auction information database, a highest bid associated with the senior life settlement policy;
compare the bid received from the buyer computer to the highest bid associated with the senior life settlement policy;
determine that the bid received from the buyer computer is higher than the highest bid;
store, in the auction information database, the bid received from the buyer computer as a new highest bid associated with the senior life settlement policy; and
determine that the auction for the senior life settlement policy is closed.

2. The method of claim 1, wherein the exchange computer is further configured to:
retrieve a first reserve price associated with the senior life settlement policy from the market listed policy database after determining that the auction for the senior life settlement policy is closed;
retrieve the new highest bid associated with the senior life settlement policy from the auction information database; and
compare the first reserve price to the new highest bid.

3. The method of claim 2, wherein the exchange computer is further configured to:
determine that the new highest bid is greater than or equal to the first reserve price;
generate an electronic communication that the senior life settlement policy was successfully auctioned; and
transmit to the securities intermediary computer the electronic communication that the senior life settlement policy was successfully auctioned, wherein said electronic communication includes the new highest bid amount.

4. The method of claim 3, wherein the exchange computer is further configured to receive, from the securities intermediary computer, an electronic communication that the successful auction of the senior life settlement policy was settled within three business days.

5. The method of claim 2, wherein the exchange computer is further configured to:
determine that the new highest bid is less than the first reserve price; and
determine that the auction for the senior life settlement policy should be extended.

6. The method of claim 5, wherein the exchange computer is further configured to:
determine a second auction end date for the senior life settlement policy; and
store the second auction end date for the senior life settlement policy in the market listed policy database.

7. The method of claim 6, wherein the exchange computer is further configured to:
determine a second reserve price for the senior life settlement policy that is lower than the first reserve price;
store the second reserve price for the senior life settlement policy in the market listed policy database; and
receive a second bid to purchase said senior life settlement policy after the second reserve price for the senior life settlement policy has been stored in the market listed policy database.

8. An exchange system for conducting an auction of a senior life settlement policy, said exchange system comprising:
an exchange computer;
a market listed policy database;
an auction information database;
wherein the exchange computer is configured to:
receive, from a securities intermediary computer, data representing that title to a senior life settlement policy is held by a third party securities intermediary;
receive, from a seller computer, dynamic policy data associated with the senior life settlement policy;
store, in a market listed policy database, the dynamic policy data associated with the senior life settlement policy;
determine that the senior life settlement policy is available for auction;
receive, from a buyer computer, a bid to purchase the senior life settlement policy;
retrieve, from an auction information database, a highest bid associated with the senior life settlement policy;
compare the bid received from the buyer computer to the highest bid associated with the senior life settlement policy;
determine that the bid received from the buyer computer is higher than the highest bid;
store, in the auction information database, the bid received from the buyer computer as a new highest bid associated with the senior life settlement policy; and
determine that the auction for the senior life settlement policy is closed.

9. The exchange system of claim 8, wherein the exchange computer is further configured to:
retrieve a first reserve price associated with the senior life settlement policy from the market listed policy database after determining that the auction for the senior life settlement policy is closed;
retrieve the new highest bid associated with the senior life settlement policy from the auction information database; and
compare the first reserve price to the new highest bid.

10. The exchange system of claim 9, wherein the exchange computer is further configured to:
determine that the new highest bid is greater than or equal to the first reserve price;
generate an electronic communication that the senior life settlement policy was successfully auctioned; and
transmit to the securities intermediary computer the electronic communication that the senior life settlement policy was successfully auctioned, wherein said electronic communication includes the new highest bid amount.

11. The exchange system of claim 10, wherein the exchange computer is further configured to receive, from the securities intermediary computer, an electronic communication that the successful auction of the senior life settlement policy was settled within three business days.

12. The exchange system of claim 9, wherein the exchange computer is further configured to:
determine that the new highest bid is less than the first reserve price; and
determine that the auction for the senior life settlement policy should be extended.

13. The exchange system of claim 12, wherein the exchange computer is further configured to:
determine a second auction end date for the senior life settlement policy; and
store the second auction end date for the senior life settlement policy in the market listed policy database.

14. The exchange system of claim 13, wherein the exchange computer is further configured to:
determine a second reserve price for the senior life settlement policy that is lower than the first reserve price;
store the second reserve price for the senior life settlement policy in the market listed policy database; and
receive a second bid to purchase said senior life settlement policy after the second reserve price for the senior life settlement policy has been stored in the market listed policy database.

15. At least one computer-readable medium including instructions that are executable to cause a system to perform operations comprising:
receiving, from a securities intermediary computer, data representing that title to a senior life settlement policy is held by a third party securities intermediary;
receiving, from a seller computer, dynamic policy data associated with the senior life settlement policy;
storing, in a market listed policy database, the dynamic policy data associated with the senior life settlement policy;
determining that the senior life settlement policy is available for auction;
receiving, from a buyer computer, a bid to purchase the senior life settlement policy;
retrieving, from an auction information database, a highest bid associated with the senior life settlement policy;
comparing the bid received from the buyer computer to the highest bid associated with the senior life settlement policy;
determining that the bid received from the buyer computer is higher than the highest bid;
storing, in the auction information database, the bid received from the buyer computer as a new highest bid associated with the senior life settlement policy; and
determining that the auction for the senior life settlement policy is closed.

16. The at least one computer-readable medium of claim 15, wherein the instructions are executable to cause the system to perform further operations comprising:
retrieving a first reserve price associated with the senior life settlement policy from the market listed policy database after determining that the auction for the senior life settlement policy is closed;
retrieving the new highest bid associated with the senior life settlement policy from the auction information database; and
comparing the first reserve price to the new highest bid.

17. The at least one computer-readable medium of claim 16, wherein the instructions are executable to cause the system to perform further operations comprising:
determining that the new highest bid is greater than or equal to the first reserve price;
generating an electronic communication that the senior life settlement policy was successfully auctioned; and
transmitting to the securities intermediary computer the electronic communication that the senior life settlement policy was successfully auctioned, wherein said electronic communication includes the new highest bid amount.

18. The at least one computer-readable medium of claim 17, wherein the instructions are executable to cause the system to perform further operations comprising receiving, from the securities intermediary computer, an electronic communication that the successful auction of the senior life settlement policy was settled within three business days.

19. The at least one computer-readable medium of claim 16, wherein the instructions are executable to cause the system to perform further operations comprising:
determining that the new highest bid is less than the first reserve price;
determining that the auction for the senior life settlement policy should be extended;
determining a second auction end date for the senior life settlement policy; and
storing the second auction end date for the senior life settlement policy in the market listed policy database.

20. The at least one computer-readable medium of claim 19, wherein the instructions are executable to cause the system to perform further operations comprising:
determining a second reserve price for the senior life settlement policy that is lower than the first reserve price;
storing the second reserve price for the senior life settlement policy in the market listed policy database; and
receiving a second bid to purchase said senior life settlement policy after the second reserve price for the senior life settlement policy has been stored in the market listed policy database.
